(19) United States
(12) Patent Application Publication
(10) Pub. No.: US 2023/0224987 A1
(43) Pub. Date: Jul. 13, 2023

(54) METHOD AND APPARATUS FOR PERFORMING SIDELINK-BASED RELAY COMMUNICATION IN WIRELESS COMMUNICATION SYSTEM

(71) Applicant: LG ELECTRONICS INC., Seoul (KR)

(72) Inventors: Byounggill KIM, Seoul (KR); Dong Hwan KIM, Seoul (KR); Young Dae KIM, Seoul (KR)

(21) Appl. No.: 18/009,577

(22) PCT Filed: Jun. 7, 2021
(86) PCT No.: PCT/KR2021/007097

§ 371 Date: Dec. 9, 2022

(30) Foreign Application Priority Data
Jun. 25, 2020 (KR) 10-2020-0077807
Nov. 25, 2020 (KR) 10-2020-0160222

(51) Int. Cl. H04W 76/14; H04W 8/00

(52) U.S. Cl. CPC H04W 76/14; H04W 8/005; H04W 88/04

(57) ABSTRACT

The present disclosure relates to relay communication based on a sidelink in a wireless communication system, and a method for operating a first terminal may include performing direct communication with a second terminal based on a sidelink, when a path between the first terminal and the second terminal is predicted to be blocked and another relay device providing a relay service is discovered, transmitting, to the relay device, a first message for requesting the relay service for the first terminal and the second terminal, receiving, from the relay device, a second message for accepting the request for the relay service, and performing relay communication with the second terminal, and the first message may include information on the second terminal.

### TECHNICAL FIELD

The present disclosure relates to a wireless communication system and, more particularly, to a method and device for performing sidelink-based relay communication in a wireless communication system.

### BACKGROUND

A wireless communication system is a multiple access system that supports communication of multiple users by sharing available system resources (e.g., a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (mMTC), Ultra-Reliable and Low Latency Communication (URLLC), and so on, may be referred to as a new radio access technology (RAT) or new radio (NR). Herein, the NR may also support vehicle-to-everything (V2X) communication.

### SUMMARY

The present disclosure relates to a method and device for effectively performing sidelink-based relay communication in a wireless communication system.

The present disclosure relates to a method and device for performing communication by using relay communication in case of path blocking during direct communication in a wireless communication system.

The present disclosure relates to a method and device for solving a temporary path block situation during direct communication by using a relay service in a wireless communication system.

The present disclosure relates to a method and device for providing information on a counterpart terminal, when requesting a relay service, in a wireless communication system.

The present disclosure relates to a method and device for determining whether or not to terminate a delay service that started due to temporary path blocking in a wireless communication system.

The technical objects to be achieved in the present disclosure are not limited to the above-mentioned technical objects, and other technical objects that are not mentioned may be considered by those skilled in the art through the embodiments described below.

### Technical Solution

As an example of the present disclosure, a method for operating a first terminal in a wireless communication system may include performing direct communication with a second terminal based on a sidelink, when a path between the first terminal and the second terminal is predicted to be blocked and another relay device providing a relay service is discovered, transmitting, to the relay device, a first message for requesting the relay service for the first terminal and the second terminal, receiving, from the relay device, a second message for accepting the request for the relay service, and performing relay communication with the second terminal, and the first message may include information on the second terminal.

As an example of the present disclosure, a method for operating a second terminal in a wireless communication system may include performing direct communication with a first terminal based on a sidelink, receiving a first message for informing that relay communication is performed since a path between the first terminal and the second terminal is predicted to be blocked, and performing the relay communication with the first terminal.

As an example of the present disclosure, a method for operating a relay device in a wireless communication system may include receiving a first message for requesting a relay service for a first terminal and a second terminal from the first terminal that is performing direct communication with the second terminal, transmitting, to the first terminal, a second message for accepting the request for the relay service, and providing the relay service to the first terminal and the second terminal, and the first message may include information on the second terminal.

As an example of the present disclosure, a first terminal in a wireless communication system may include a transceiver and a processor coupled with the transceiver. The processor may be configured to perform direct communication with a second terminal based on a sidelink, when a path between the first terminal and the second terminal is predicted to be blocked and another relay device providing a relay service is discovered, to transmit, to the relay device, a first message for requesting the relay service for the first terminal and the second terminal, to receive, from the relay device, a second message for accepting the request for the relay service, and to perform relay communication with the second terminal, and the first message includes information on the second terminal.

As an example of the present disclosure, a second terminal in a wireless communication system may include a transceiver and a processor coupled with the transceiver, and the processor may be configured to perform direct communication with a first terminal based on a sidelink, to receive a first message for informing that relay communication is performed since a path between the first terminal and the second terminal is predicted to be blocked, and to perform the relay communication with the first terminal.

As an example of the present disclosure, a relay device in a wireless communication system may include a transceiver and a processor coupled with the transceiver, and the processor may be configured to receive a first message for requesting a relay service for a first terminal and a second terminal from the first terminal that is performing direct communication with the second terminal, to transmit, to the first terminal, a second message for accepting the request for the relay service, and to provide the relay service to the first terminal and the second terminal, and the first message may include information on the second terminal.

As an example of the present disclosure, a device may include at least one memory and at least one processor functionally coupled with the at least one memory. The at least one processor may control the device to perform direct communication with another device based on a sidelink, when a path between the device and the another device is predicted to be blocked and another relay device providing a relay service is discovered, to transmit, to the relay device, a first message for requesting the relay service for the device and the another device, to receive, from the relay device, a second message for accepting the request for the relay service, and to perform relay communication with the another device, and the first message may include information on the another device.

As an example of the present disclosure, a non-transitory computer-readable medium storing at least one instruction may include the at least one instruction executable by a processor, and the at least one instruction may instruct a device to perform direct communication with another device based on a sidelink, when a path between the device and the another device is predicted to be blocked and another relay device providing a relay service is discovered, to transmit, to the relay device, a first message for requesting the relay service for the device and the another device, to receive, from the relay device, a second message for accepting the request for the relay service, and to perform relay communication with the another device, and the first message may include information on the another device.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

According to the present disclosure, communication may be maintained by using relay communication in a situation where a path is blocked during direct communication.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates a structure of a wireless communication system, in accordance with an embodiment of the present disclosure.

FIG. 2 illustrates a functional division between an NG-RAN and a SGC, in accordance with an embodiment of the present disclosure.

FIG. 3 illustrates a radio protocol architecture, in accordance with an embodiment of the present disclosure.

FIG. 4 illustrates a structure of a radio frame in an NR system, in accordance with an embodiment of the present disclosure.

FIG. 5 illustrates a structure of a slot in an NR frame, in accordance with an embodiment of the present disclosure.

FIG. 6 illustrates an example of a BWP, in accordance with an embodiment of the present disclosure.

FIGS. 7A and 7B illustrate a radio protocol architecture for a SL communication, in accordance with an embodiment of the present disclosure.

FIG. 8 illustrates a synchronization source or synchronization reference of V2X, in accordance with an embodiment of the present disclosure.

FIGS. 9A and 9B illustrate a procedure of performing V2X or SL communication by a terminal based on a transmission mode, in accordance with an embodiment of the present disclosure.

FIGS. 10A to 10C illustrate three cast types, in accordance with an embodiment of the present disclosure.

FIG. 11 illustrates a concept of relay communication based on a sidelink in a wireless communication system according to an embodiment of the present disclosure.

FIG. 12 illustrates an example of a method performed by a terminal requesting relay communication in a wireless communication system according to an embodiment of the present disclosure.

FIG. 13 illustrates an example of a method performed by a terminal participating in relay communication in a wireless communication system according to an embodiment of the present disclosure.

FIG. 14 illustrates an example of a method performed by a relay device in a wireless communication system according to an embodiment of the present disclosure.

FIG. 15 illustrates an example of a scenario in which relay communication is performed by turning at an intersection in a wireless communication system according to an embodiment of the present disclosure.

FIG. 16 illustrates an example of a procedure for relay communication by turning at an intersection in a wireless communication system according to an embodiment of the present disclosure.

FIG. 17 illustrates an example of a scenario in which relay communication is performed by another vehicle's cutting in line in a wireless communication system according to an embodiment of the present disclosure.

FIG. 18 illustrates an example of a scenario in which relay communication is terminated in a wireless communication system according to an embodiment of the present disclosure.

FIG. 19 illustrates an example of a procedure for terminating relay communication based on an angle between beams in a wireless communication system according to an embodiment of the present disclosure.

FIG. 20 illustrates a communication system, in accordance with an embodiment of the present disclosure.

FIG. 21 illustrates wireless devices, in accordance with an embodiment of the present disclosure.

FIG. 22 illustrates a signal process circuit for a transmission signal, in accordance with an embodiment of the present disclosure.

FIG. 23 illustrates a wireless device, in accordance with an embodiment of the present disclosure.

FIG. 24 illustrates a hand-held device, in accordance with an embodiment of the present disclosure.

FIG. 25 illustrates a car or an autonomous vehicle, in accordance with an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the present specification, “A or B” may mean “only A”, “only B” or “both A and B.” In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDDCH” may be proposed as an example of the “control information”. In addition, when indicated as “control information (i.e., PDCCH)”, it may also mean that “PDCCH” is proposed as an example of the “control information”.

In the following description, ‘when, if, or in case of may be replaced with ‘based on’.

A technical feature described individually in one figure in the present specification may be individually implemented, or may be simultaneously implemented.

In the present disclosure, a higher layer parameter may be a parameter which is configured, pre-configured or pre-defined for a UE. For example, a base station or a network may transmit the higher layer parameter to the UE. For example, the higher layer parameter may be transmitted through radio resource control (RRC) signaling or medium access control (MAC) signaling.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

For terms and techniques not specifically described among terms and techniques used in the present disclosure, reference may be made to a wireless communication standard document published before the present disclosure is filed. For example, the following document may be referred to.

(1) 3GPP LTE
3GPP TS 36.211: Physical channels and modulation
3GPP TS 36.212: Multiplexing and channel coding
3GPP TS 36.213: Physical layer procedures
3GPP TS 36.214: Physical layer; Measurements
3GPP TS 36.300: Overall description
3GPP TS 36.304: User Equipment (UE) procedures in idle mode
3GPP TS 36.314: Layer 2—Measurements
3GPP TS 36.321: Medium Access Control (MAC) protocol
3GPP TS 36.322: Radio Link Control (RLC) protocol
3GPP TS 36.323: Packet Data Convergence Protocol (PDCP)
3GPP TS 36.331: Radio Resource Control (RRC) protocol

(2) 3GPP NR (e.g. 5G)
3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: Overall description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description

Communication System Applicable to the Present Disclosure

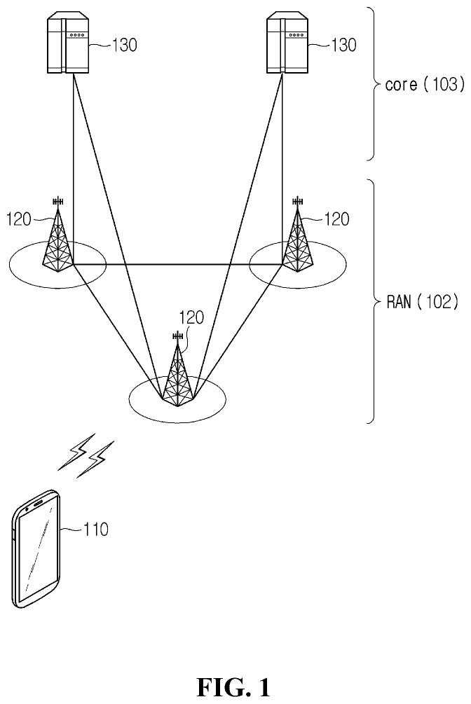

FIG. 1 illustrates a structure of a wireless communication system according to an embodiment of the present disclosure. The embodiment of FIG. 1 may be combined with various embodiments of the present disclosure.

Referring to FIG. 1, a wireless communication system includes a radio access network (RAN) 102 and a core network 103. The radio access network 102 includes a base station 120 that provides a control plane and a user plane to a terminal 110. The terminal 110 may be fixed or mobile, and may be called other terms such as a user equipment (UE), a mobile station (MS), a subscriber station (SS), a mobile subscriber station (MSS), a mobile terminal, an advanced mobile station (AMS), or a wireless device. The base station 120 refers to a node that provides a radio access service to the terminal 110, and may be called other terms such as a fixed station, a Node B, an eNB (eNode B), a gNB (gNode B), an ng-eNB, an advanced base station (ABS), an access point, a base transceiver system (BTS), or an access point (AP). The core network 103 includes a core network entity 130. The core network entity 130 may be defined in various ways according to functions, and may be called other terms such as a core network node, a network node, or a network equipment.

Components of a system may be referred to differently according to an applied system standard. In the case of the LTE or LTE-A standard, the radio access network 102 may be referred to as an Evolved-UMTS Terrestrial Radio Access Network (E-UTRAN), and the core network 103 may be referred to as an evolved packet core (EPC). In this case, the core network 103 includes a Mobility Management Entity (MME), a Serving Gateway (S-GW), and a packet data network-gateway (P-GW). The MME has access information of the terminal or information on the capability of the terminal, and this information is mainly used for mobility management of the terminal. The S-GW is a gateway having an E-UTRAN as an endpoint, and the P-GW is a gateway having a packet data network (PDN) as an endpoint.

In the case of the 5G NR standard, the radio access network 102 may be referred to as an NG-RAN, and the core network 103 may be referred to as a 5GC (5G core). In this case, the core network 103 includes an access and mobility management function (AMF), a user plane function (UPF), and a session management function (SMF). The AMF provides a function for access and mobility management in units of terminals, the UPF performs a function of mutually transmitting data units between an upper data network and the radio access network 102, and the SMF provides a session management function.

The BSs 120 may be connected to one another via Xn interface. The BS 120 may be connected to one another via core network 103 and NG interface. More specifically, the BSs 130 may be connected to an access and mobility management function (AMF) via NG-C interface, and may be connected to a user plane function (UPF) via NG-U interface.

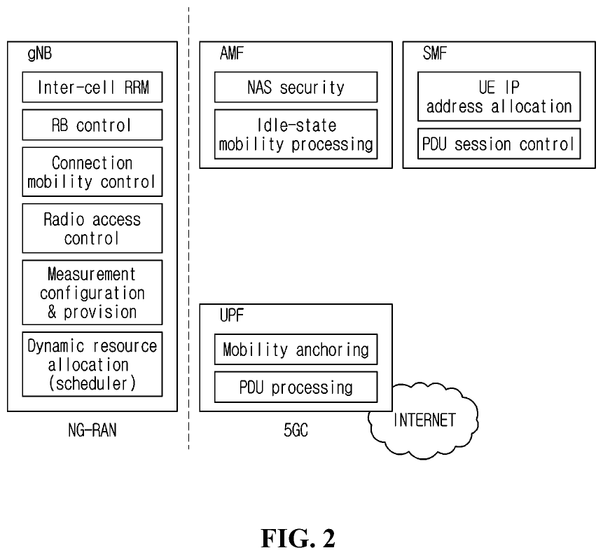

FIG. 2 illustrates a functional division between an NG-RAN and a 5GC, in accordance with an embodiment of the present disclosure. The embodiment of FIG. 2 may be combined with various embodiments of the present disclosure.

Referring to FIG. 2, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring, Protocol Data Unit (PDU) processing, and so on. A Session Management Function (SMF) may provide functions, such as user equipment (UE) Internet Protocol (IP) address allocation, PDU session control, and so on.

Layers of a radio interface protocol between the UE and the network can be classified into a first layer (layer 1, L1), a second layer (layer 2, L2), and a third layer (layer 3, L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer enable to exchange an RRC message between the UE and the BS.

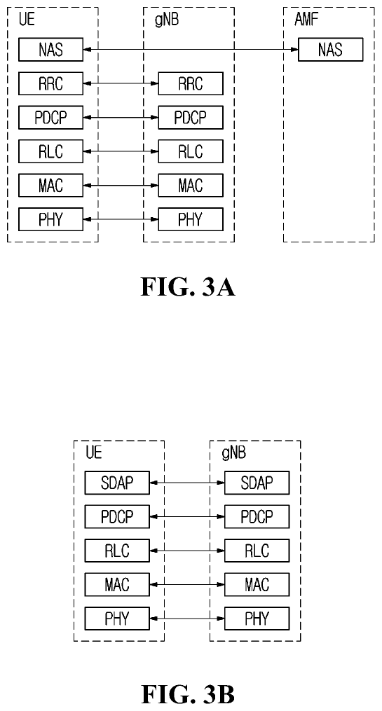

FIGS. 3A and 3B illustrate a radio protocol architecture, in accordance with an embodiment of the present disclosure. The embodiment of FIG. 3 may be combined with various embodiments of the present disclosure. Specifically, FIG. 3A exemplifies a radio protocol architecture for a user plane, and FIG. 3B exemplifies a radio protocol architecture for a control plane. The user plane corresponds to a protocol stack for user data transmission, and the control plane corresponds to a protocol stack for control signal transmission.

Referring to FIGS. 3A and 3B, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PI-TY layer) and the second layer (i.e., the MAC layer, the RLC layer, and the packet data convergence protocol (PDCP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several sub-carriers in a frequency domain. One sub-frame includes a plurality of OFDM symbols in the time domain. A resource block is a unit of resource allocation, and consists of a plurality of OFDM symbols and a plurality of sub-carriers. Further, each subframe may use specific sub-carriers of specific OFDM symbols (e.g., a first OFDM symbol) of a corresponding subframe for a physical downlink control channel (PDCCH), i.e., an L1/L2 control channel. A transmission time interval (TTI) is a unit time of subframe transmission.

Radio Resource Structure

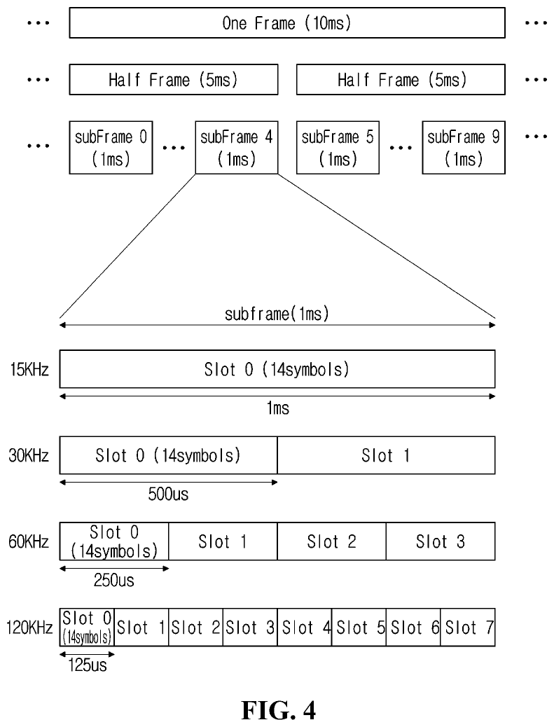

FIG. 4 illustrates a structure of a radio frame in an NR system, in accordance with an embodiment of the present disclosure. The embodiment of FIG. 4 may be combined with various embodiments of the present disclosure.

Referring to FIG. 4, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined in accordance with subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

In a case where a normal CP is used, a number of symbols per slot (N^{slot}_{symb}), a number slots per frame (N^{frame,μ}ₛₗₒₜ), and a number of slots per subframe (N^{subframe,μ}ₛₗₒₜ) may be varied based on an SCS configuration (μ). For instance, SCS(=15*2^{μ}), N^{slot}_{symb}, N^{frame,μ}ₛₗₒₜ and N^{subframe,μ}ₛₗₒₜ are 15 KHz, 14, 10 and 1, respectively, when μ=0, are 30 KHz, 14, 20 and 2, respectively, when μ=1, are 60 KHz, 14, 40 and 4, respectively, when μ=2, are 120 KHz, 14, 80 and 8, respectively, when μ=3, or are 240 KHz, 14, 160 and 16, respectively, when μ=4. Meanwhile, in a case where an extended CP is used, SCS (=15*2N^{slot}_{symb}, N^{frame,μ} and N^{subframe,μ} are 60 KHz, 12, 40 and 2, respectively, when μ=2.

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells. In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, frequency ranges corresponding to the FR1 and FR2 may be 450 MHz-6000 MHz and 24250 MHz-52600 MHz, respectively. Further, supportable SCSs is 15, 30 and 60 kHz for the FR1 and 60, 120, 240 kHz for the FR2. Among the frequency ranges that are used in an NR system, FR1 may mean a “sub 6 GHz range”, and FR2 may mean an “above 6 GHz range” and may also be referred to as a millimeter wave (mmW).

As described above, the values of the frequency ranges in the NR system may be changed (or varied). For example, comparing to examples for the frequency ranges described above, FR1 may be defined to include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

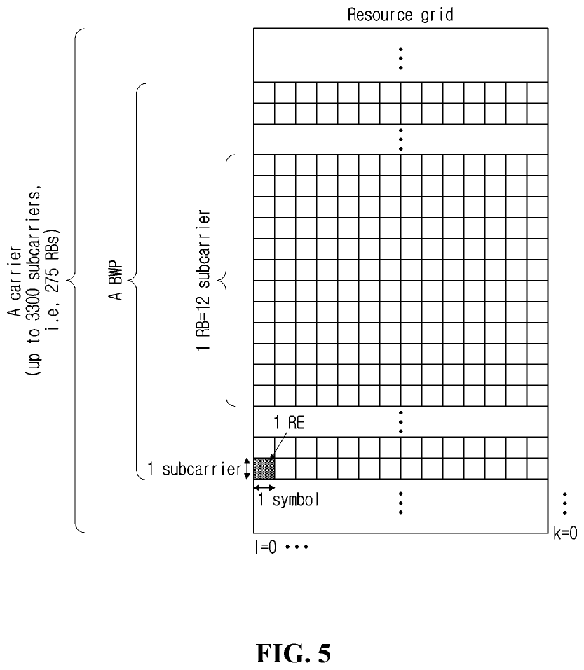

FIG. 5 illustrates a structure of a slot of an NR frame, in accordance with an embodiment of the present disclosure. The embodiment of FIG. 5 may be combined with various embodiments of the present disclosure.

Referring to FIG. 5, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Meanwhile, a radio interface between a UE and another UE or a radio interface between the UE and a network may consist of an L1 layer, an L2 layer, and an L3 layer. In various embodiments of the present disclosure, the L1 layer may imply a physical layer. In addition, for example, the L2 layer may imply at least one of a MAC layer, an RLC layer, a PDCP layer, and an SDAP layer. In addition, for example, the L3 layer may imply an RRC layer.

Bandwidth Part (BWP)

The BWP may be a set of consecutive physical resource blocks (PRBs) in a given numerology. The PRB may be selected from consecutive sub-sets of common resource blocks (CRBs) for the given numerology on a given carrier.

When using bandwidth adaptation (BA), a reception bandwidth and transmission bandwidth of a UE are not necessarily as large as a bandwidth of a cell, and the reception bandwidth and transmission bandwidth of the BS may be adjusted. For example, a network/BS may inform the UE of bandwidth adjustment. For example, the UE receive information/configuration for bandwidth adjustment from the network/BS. In this case, the UE may perform bandwidth adjustment based on the received information/configuration. For example, the bandwidth adjustment may include an increase/decrease of the bandwidth, a position change of the bandwidth, or a change in subcarrier spacing of the bandwidth.

For example, the bandwidth may be decreased during a period in which activity is low to save power. For example, the position of the bandwidth may move in a frequency domain. For example, the position of the bandwidth may move in the frequency domain to increase scheduling flexibility. For example, the subcarrier spacing of the bandwidth may be changed. For example, the subcarrier spacing of the bandwidth may be changed to allow a different service. A subset of a total cell bandwidth of a cell may be called a bandwidth part (BWP). The BA may be performed when the BS/network configures the BWP to the UE and the BS/network informs the UE of the BWP currently in an active state among the configured BWPs.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, PDSCH, or CSI-RS (excluding RRM) outside the active DL BWP. For example, the UE may not trigger a channel state information (CSI) report for the inactive DL BWP. For example, the UE may not transmit a Physical Uplink Control Channel (PUCCH) or a Physical Uplink Shared Channel (PUSCH) outside an active UL BWP. For example, in a downlink case, the initial BWP may be given as a consecutive RB set for a remaining minimum system information (RMSI) control resource set (CORESET) (configured by PBCH). For example, in an uplink case, the initial BWP may be given by system information block (SIB) for a random access procedure. For example, the default BWP may be configured by a higher layer. For example, an initial value of the default BWP may be an initial DL BWP. For energy saving, if the UE fails to detect downlink control information (DCI) during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

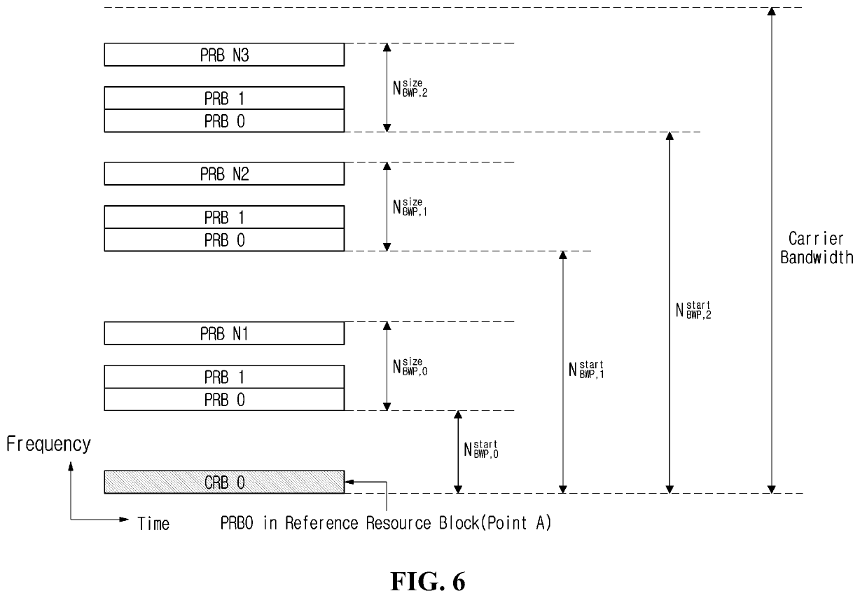

FIG. 6 illustrates an example of a BWP, in accordance with an embodiment of the present disclosure. The embodiment of FIG. 6 may be combined with various embodiments of the present disclosure. It is assumed in the embodiment of FIG. 6 that the number of BWPs is 3.

Referring to FIG. 6, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset (N^{start}_{BWP}) from the point A, and a bandwidth (N^{size}_{BWP}). For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

V2X or Sidelink Communication

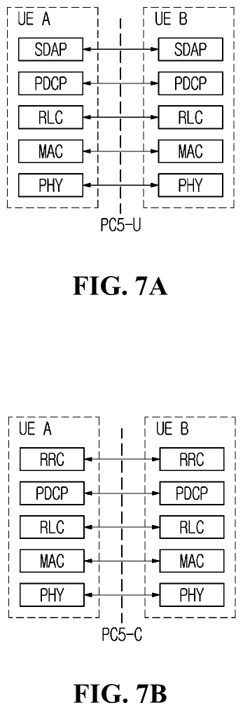

FIGS. 7A and 7B illustrate a radio protocol architecture for a SL communication, in accordance with an embodiment of the present disclosure. The embodiment of FIGS. 7A and 7B may be combined with various embodiments of the present disclosure. More specifically, FIG. 7A exemplifies a user plane protocol stack, and FIG. 7B exemplifies a control plane protocol stack.

Sidelink Synchronization Signal (SLSS) and Synchronization Information

The SLSS may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit CRC.

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-) configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

For example, based on Table 1, the UE may generate an S-SS/PSBCH block (i.e., S-SSB), and the UE may transmit the S-SS/PSBCH block (i.e., S-SSB) by mapping it on a physical resource.

TABLE 1
▪ Time-frequency structure of an S-SS/PSBCH block
in the time domain, an S-SS/PSBCH block consists
of N_{symb}^{S-SSB} OFDM symbols, numbered in
increasing order from 0 to N_{symb}^{S-SSB} − 1 within the
S-SS/PSBCH block, where S-PSS, S-SSS,
and PSBCH with associated DM-RS are mapped
to symbols as given by Table 8.4.3.1-1.
The number of OFDM symbols in an S-SS/PSBCH
block N_{symb}^{S-SSB} = 13 for normal cyclic
prefix and N_{symb}^{S-SSB} = 11 for extended cyclic
prefix. The first OFDM symbol in an S-
SS/PSBCH block is the first OFDM symbol in the slot.
In the frequency domain, an S-SS/PSBCH block
consists of 132 contiguous subcarriers with
the subcarriers numbered in increasing
order from 0 to 131 within the sidelink S-
SS/PSBCH block. The quantities k and l
represent the frequency and time indices.
respectively, within one sidelink S-SS/PSBCH block.
For an S-SS/PSBCH block, the UE shall use
- antenna port 4000 for transmission of
S-PSS, S-SSS, PSBCH and DM-RS for PSBCH:
- the same cyclic prefix length and subcarrier spacing for
the S-PSS, S-SSS, PSBCH and DM-RS for PSBCH.
Table 8.4.3.1-1: Resources within an S-SS/PSBCH block
for S-PSS, S-SSS, PSBCH, and DM-RS.

| | OFDM symbol number l | Subcarrier number k |
|---|---|---|
| Channel | relative to the start of an | relative to the start of an |
| or signal | S-SS/PSBCH block | S-SS/PSBCH block |
| S-PSS | 1, 2 | 2, 3, . . . , 127, 128 |
| S-SSS | 3, 4 | 2, 3, . . . , 127, 128 |
| Set to | 1, 2, 3, 4 | 0, 1, 129, 130, 131 |
| zero | | |
| PSBCH | 0, 5, 6, . . . , N_{symb}^{S-SSB} − 1 | 0, 1, . . . , 131 |
| DM-RS for | 0, 5, 6, . . . , N_{symb}^{S-SSS} − 1 | 0, 4, 8, . . . , 128 |
| PSBCH | | |

Synchronization Acquisition of SL Terminal

In TDMA and FDMA systems, accurate time and frequency synchronization is essential. Inaccurate time and frequency synchronization may lead to degradation of system performance due to inter-symbol interference (ISI) and inter-carrier interference (ICI). The same is true for V2X. For time/frequency synchronization in V2X, a sidelink synchronization signal (SLSS) may be used in the PHY layer, and master information block-sidelink-V2X (MIB-SL-V2X) may be used in the RLC layer.

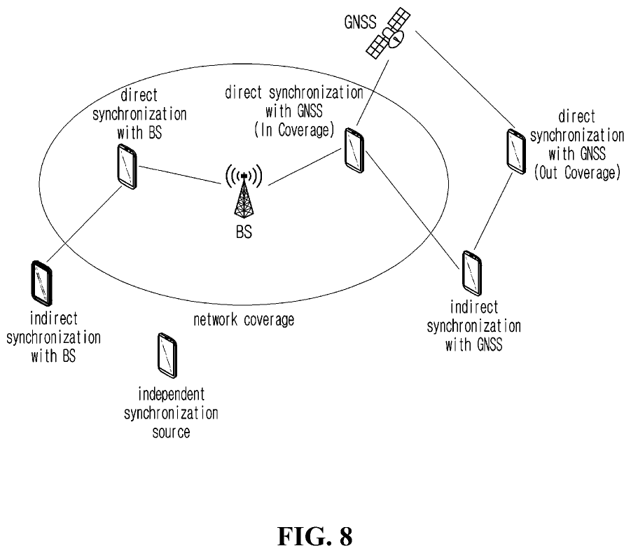

FIG. 8 illustrates a synchronization source or synchronization reference of V2X, in accordance with an embodiment of the present disclosure. The embodiment of FIG. 8 may be combined with various embodiments of the present disclosure.

Referring to FIG. 8, in V2X, a UE may be synchronized with a GNSS directly or indirectly through a UE (within or out of network coverage) directly synchronized with the GNSS. When the GNSS is configured as a synchronization source, the UE may calculate a direct subframe number (DFN) and a subframe number by using a coordinated universal time (UTC) and a (pre)determined DFN offset.

Alternatively, the UE may be synchronized with a BS directly or with another UE which has been time/frequency synchronized with the BS. For example, the BS may be an eNB or a gNB. For example, when the UE is in network coverage, the UE may receive synchronization information provided by the BS and may be directly synchronized with the BS. Thereafter, the UE may provide synchronization information to another neighboring UE. When a BS timing is set as a synchronization reference, the UE may follow a cell associated with a corresponding frequency (when within the cell coverage in the frequency), a primary cell, or a serving cell (when out of cell coverage in the frequency), for synchronization and DL measurement.

The BS (e.g., serving cell) may provide a synchronization configuration for a carrier used for V2X or SL communication. In this case, the UE may follow the synchronization configuration received from the BS. When the UE fails in detecting any cell in the carrier used for the V2X or SL communication and receiving the synchronization configuration from the serving cell, the UE may follow a predetermined synchronization configuration.

Alternatively, the UE may be synchronized with another UE which has not obtained synchronization information directly or indirectly from the BS or GNSS. A synchronization source and a preference may be preset for the UE. Alternatively, the synchronization source and the preference may be configured for the UE by a control message provided by the BS.

An SL synchronization source may be related to a synchronization priority. For example, the relationship between synchronization sources and synchronization priorities may be defined as shown in [Table 2] or [Table 3]. [Table 2] or [Table 3] is merely an example, and the relationship between synchronization sources and synchronization priorities may be defined in various manners.

TABLE 2

| Priority | GNSS-based | |
|---|---|---|
| Level | synchronization | eNB/gNB-based synchronization |
| P0 | GNSS | eNB/gNB |
| P1 | All UEs synchronized | All UEs synchronized directly with |
| | directly with GNSS | NB/gNB |
| P2 | All UEs synchronized | All UEs synchronized indirectly with |
| | indirectly with GNSS | eNB/gNB |
| P3 | All other UEs | GNSS |
| P4 | N/A | All UEs synchronized directly with |
| | | GNSS |
| P5 | N/A | All UEs synchronized indirectly with |
| | | GNSS |
| P6 | N/A | All other UEs |

TABLE 3

| Priority | GNSS-based | |
|---|---|---|
| Level | synchronization | eNB/gNB-based synchronization |
| P0 | GNSS | eNB/gNB |
| P1 | All UEs synchronized | All UEs synchronized directly with |
| | directly with GNSS | eNB/gNB |
| P2 | All UEs synchronized | All UEs synchronized indirectly with |
| | indirectly with GNSS | eNB/gNB |
| P3 | eNB/gNB | GNSS |
| P4 | All UEs synchronized | All UEs synchronized directly with |
| | directly with eNB/gNB | GNSS |
| P5 | All UEs synchronized | All UEs synchronized indirectly with |
| | indirectly with eNB/gNB | GNSS |
| P6 | Remaining UE(s) with | Remaining UE(s) with lower priority |
| | lower priority | |

In [Table 2] or [Table 3], PO may represent a highest priority, and P6 may represent a lowest priority. In [Table 2] or [Table 3], the BS may include at least one of a gNB or an eNB.

Whether to use GNSS-based synchronization or eNB/gNB-based synchronization may be (pre)determined. In a single-carrier operation, the UE may derive its transmission timing from an available synchronization reference with the highest priority.

For example, the UE may (re)select a synchronization reference, and the UE may obtain synchronization from the synchronization reference. In addition, the UE may perform SL communication (e.g., PSCCH/PSSCH transmission/reception, physical sidelink feedback channel (PSFCH) transmission/reception, S-SSB transmission/reception, reference signal transmission/reception, etc.) based on the obtained synchronization.

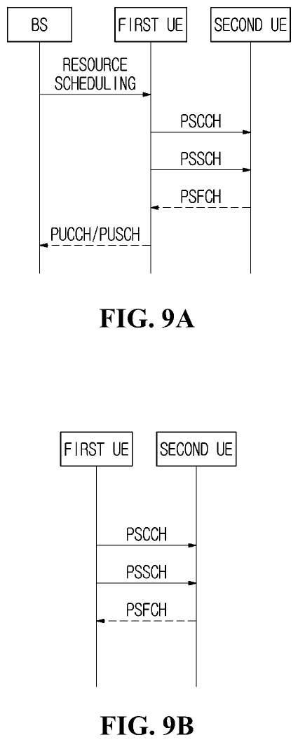

FIGS. 9A and 9B illustrate a procedure of performing V2X or SL communication by a terminal based on a transmission mode, in accordance with an embodiment of the present disclosure. The embodiment of FIGS. 9A and 9B may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, FIG. 9A exemplifies a UE operation related to an LTE transmission mode 1 or an LTE transmission mode 3. Alternatively, for example, FIG. 9B exemplifies a UE operation related to an NR resource allocation mode 1. For example, the LTE transmission mode 1 may be applied to general SL communication, and the LTE transmission mode 3 may be applied to V2X communication.

For example, FIG. 9B exemplifies a UE operation related to an LTE transmission mode 2 or an LTE transmission mode 4. Alternatively, for example, FIG. 9A exemplifies a UE operation related to an NR resource allocation mode 2.

Referring to FIG. 9A, in the LTE transmission mode 1, the LTE transmission mode 3, or the NR resource allocation mode 1, a BS may schedule an SL resource to be used by the UE for SL transmission. For example, a base station may transmit information related to SL resource(s) and/or information related to UL resource(s) to a first UE. For example, the UL resource(s) may include PUCCH resource(s) and/or PUSCH resource(s). For example, the UL resource(s) may be resource(s) for reporting SL HARQ feedback to the base station.

For example, the first UE may receive information related to dynamic grant (DG) resource(s) and/or information related to configured grant (CG) resource(s) from the base station. For example, the CG resource(s) may include CG type 1 resource(s) or CG type 2 resource(s). In the present disclosure, the DG resource(s) may be resource(s) configured/allocated by the base station to the first UE through a downlink control information (DCI). In the present disclosure, the CG resource(s) may be (periodic) resource(s) configured/allocated by the base station to the first UE through a DCI and/or an RRC message. For example, in the case of the CG type 1 resource(s), the base station may transmit an RRC message including information related to CG resource(s) to the first UE. For example, in the case of the CG type 2 resource(s), the base station may transmit an RRC message including information related to CG resource(s) to the first UE, and the base station may transmit a DCI related to activation or release of the CG resource(s) to the first UE.

Subsequently, the first UE may transmit a PSCCH (e.g., sidelink control information (SCI) or 1^{st}-stage SCI) to a second UE based on the resource scheduling. After then, the first UE may transmit a PSSCH (e.g., 2^{nd}-stage SCI, MAC PDU, data, etc.) related to the PSCCH to the second UE. After then, the first UE may receive a PSFCH related to the PSCCH/PSSCH from the second UE. For example, HARQ feedback information (e.g., NACK information or ACK information) may be received from the second UE through the PSFCH. After then, the first UE may transmit/report HARQ feedback information to the base station through the PUCCH or the PUSCH. For example, the HARQ feedback information reported to the base station may be information generated by the first UE based on the HARQ feedback information received from the second UE. For example, the HARQ feedback information reported to the base station may be information generated by the first UE based on a pre-configured rule. For example, the DCI may be a DCI for SL scheduling. For example, a format of the DCI may be a DCI format 3_0 or a DCI format 3_1. Table 4 shows an example of a DCI for SL scheduling.

TABLE 4
3GPP TS 38.212

```
▪ Format 3_0
DCI format 3_0 is used for scheduling of NR
PSCCH and NR PSSCH in one cell.
The following information is transmitted by means
of the DCI format 3_0 with CRC scrambled
by SL-RNTI or SL-CS-RNTI:
  - Resource pool index −[log₂I] bits, where
  l is the number of resource pools for
    transmission configured by the higher
    layer parameter sl-TxPoolScheduling.
  - Time gap-3 bits determined by higher
  layer parameter sl-DCI-ToSL-Trans, as
    defined in clause 8.1.2.1 of [6, TS 38.214]
  - HARQ process number-4 bits as
  defined in clause 16.4 of [5, TS 38.213]
  - New data indicator-1 bit as defined in
  clause 16.4 of [5, TS 38.213]
  - Lowest index of the subchannel allocation
  to the initial transmission −[log₂(N_{subChannel}^{SL})]
    bits as defined in clause
    8.1.2.2 of [6, TS 38.214]
- SCI format 1-A fields according
to clause 8.3.1.1:
  - Frequency resource assignment.
  - Time resource assignment.
- PSFCH-to-HARQ feedback timing indicator
  −[log₂(N_{fb}_timing] bits, where N_{fb}_timing is the
  number of entries in the higher layer
  parameter sl-PSFCH-ToPUCCH, as defined it
  clause 16.5 of [5, TS 38.213]
- PUCCH resource indicator-3 bits as
  defined in clause 16.5 of [5, TS 38.213].
- Configuration index-0 bit if the UE is not
  configured to monitor DCI format 3_0 with
  CRC scrambled by SL-CS-RNTI: otherwise
  3 bits as defined in clause 8.1.2 of [6, TS
  38.214]. If the UE is configured to monitor
  DCI format 3_0 with CRC scrambled by SL-
  CS-RNTI, this field is reserved for DCI
  format 3_0 with CRC scrambled by SL-RNTI.
- Counter sidelink assignment index-2 bits
  - 2 bits as defined in clause 16.5.2 of
  [5, TS 38.213] if the UE is configured with
    pdsch-HARQ-ACK-Codebook = dynamic
  - 2 bits as defined in clause 16.5.1 of
  [5, TS 38.213] if the UE is configured with
    pdsch-HARQ-ACK-Codebook = semi-static
- Padding bits, if required
▪ Format 3_1
DCI format 3_1 is used for scheduling of
LTE PSCCH and LTE PSSCH in one cell.
The following information is transmitted by
means of the DCI format 3_1 with CRC scramb [symbol]
by SL-L-CS-RNTI:
  - Timing offset-3 bits determined by higher
  layer parameter sl-TimeOffsetEUTRA,
    defined in clause 16.6 of [5, TS 38.213]
  - Carrier indicator-3 bits as defined in
  5.3.3.1.9A of [11, TS 36.212].
  - Lowest index of the subchannel allocation
  to the initial transmission-[log₂(N_{subChannel}^{SL}) [symbol]
    bits as defined in 5.3.3.1.9A of [11, TS 36.212].
  - Frequency resource location of initial
  transmission and retransmission, as defined [symbol]
    5.3.3.1.9A of [11, TS 36.212]
  - Time gap between initial transmission and
  retransmission, as defined in 5.3.3.1.9A [symbol]
    [11, TS 36.212]
  - SL index-2 bits as defined in 5.3.3.1.9A
  of [11, TS 36.212]
  - SL SPS configuration index-3 bits as defined
  in clause 5.3.3.1.9A of [11, TS 36.21 [symbol]
Activation/release indication-1 bit as defined in
clause 5.3.3.1.9A of [11, [symbol]  36.212]. [symbol]
indicates data missing or illegible when filed
```

Referring to FIG. 9B, in the LTE transmission mode 2, the LTE transmission mode 4, or the NR resource allocation mode 2, the UE may determine an SL transmission resource within an SL resource configured by a BS/network or a pre-configured SL resource. For example, the configured SL resource or the pre-configured SL resource may be a resource pool. For example, the UE may autonomously select or schedule a resource for SL transmission. For example, the UE may perform SL communication by autonomously selecting a resource within a configured resource pool. For example, the UE may autonomously select a resource within a selective window by performing a sensing and resource (re)selection procedure. For example, the sensing may be performed in unit of subchannel(s). For example, subsequently, a first UE which has selected resource(s) from a resource pool by itself may transmit a PSCCH (e.g., sidelink control information (SCI) or 1^{st}-stage SCI) to a second UE by using the resource(s). After then, the first UE may transmit a PSSCH (e.g., 2^{nd}-stage SCI, MAC PDU, data, etc.) related to the PSCCH to the second UE. In step S8030, the first UE may receive a PSFCH related to the PSCCH/PSSCH from the second UE.

Referring to FIGS. 9A and 9B, for example, the first UE may transmit a SCI to the second UE through the PSCCH. Alternatively, for example, the first UE may transmit two consecutive SCIs (e.g., 2-stage SCI) to the second UE through the PSCCH and/or the PSSCH. In this case, the second UE may decode two consecutive SCIs (e.g., 2-stage SCI) to receive the PSSCH from the first UE. In the present disclosure, a SCI transmitted through a PSCCH may be referred to as a 1^{st} SCI, a first SCI, a 1^{st}-stage SCI or a 1^{st}-stage SCI format, and a SCI transmitted through a PSSCH may be referred to as a 2^{nd} SCI, a second SCI, a 2^{nd}-stage SCI or a 2^{nd}-stage SCI format. For example, the 1^{st}-stage SCI format may include a SCI format 1-A, and the 2^{nd}-stage SCI format may include a SCI format 2-A and/or a SCI format 2-B. Table 5 shows an example of a 1^{st}-stage SCI format.

```
TABLE 5
3GPP TS 38.212
▪ SCI format 1-A
SCI format 1-A is used for the scheduling of PSSCH and 2^{nd}-stage-SCI on PSSCH
The following information is transmitted by means of the SCI format 1-A:
    Priority-3 bits as specified in clause 5.4.3.3 of [12, TS 23.287] and clause 5.22.1.3.1
    of [8, TS 38.321].
    $\text{Frequency resource assignment} ‐ ⌈ {log}_{2} ( \frac{{N}_{subChannel}^{SL} ( {N}_{subchannel}^{SL} + 1 )}{2} ) ⌉ \text{bits when the value of}$
    the higher layer parameter sl-MaxNumPerReserve is configured to 2; otherwise
    $⌈ {log}_{2} ( \frac{{N}_{subChannel}^{SL} ( {N}_{subchannel}^{SL} + 1 ) ( 2 {N}_{subChannel}^{SL} + 1 )}{6} ) ⌉ \text{bits when the value of higher layer}$
    parameter sl-MaxNumPerReserver is configured to 3. as defined in clause 8.1.2.2 of
    [6, TS 38.214].
    Time resource assignment-5 bits when the value of the higher layer parameter
    sl-MaxNumPerReserve is configured to 2; otherwise 9 bits when the value of the higher
    layer parameter sl-MaxNumPerReserve is configured to 3. as defined in clause 8.1.2.1 of
    [6, TS 38.214].
    Resource reservation period-[log₂ Nᵣₛᵥ_period] bits as defined in clause 8.1.4 of [6, TS 38.214],
    where Nᵣₛᵥ_period is the number of entries in the higher layer parameter
    sl-ResourceReservePeriodList, if higher layer parameter sl-MultiReserveResource is
    configured; 0 bit otherwise.
  DMRS pattern-[log₂ Nₚₐₜₜₑᵣₙ] bits as defined in clause 8.4.1.1.2 of [4, TS 38.211], where
  Nₚₐₜₜₑᵣₙ is the number of DMRS patterns configured by higher layer parameter
  sl-PSSCH-DMRS-TimePatternList.
  2^{nd}-stage SCI format-2 bits as defined in Table 8.3.1.1-1.
  Beta_offset indicator-2 bits as provided by higher layer parameter sl-BetaOffsets2ndSCI and
  Table 8.3.1.1-2.
  Number of DMRS port-1 bit as defined in Table 8.3.1.1-3
  Modulation and coding scheme-5 bits as defined in clause 8.1.3 of [6, TS 38.214].
  Additional MCS table indicator-as define in clause 8.1.3.1 of [6, TS 38.214]: 1 bit if
  one MCS table is confgured by higher layer parameter sl-Additional-MCS-Table: 2 bits if
  two MCS tables are configured by higher layer parameter sl-Additional-MCS-Table;
  0 bit otherwise.
  PSFCH overhead indication-1 bit as defined clause 8.1.3.2 of [6, TS 38.214] if higher
  layer parameter sl-PSFCH-Period = 2 or 4; 0 bit otherwise.
  Reserved-a number of bits as determined by higher layer parameter sl-NumReservedBits,
  with value set to zero.
Table 8.3.1.1-1: 2^{nd}- stage SCI formats
```

| Value of 2nd-stage | |
|---|---|
| SCI format field | 2nd-stage SCI format |
| 00 | SCI format 2-A |
| 01 | SCI format 2-B |
| 10 | Reserved |
| 11 | Reserved |

Table 8.3.1.1-2: Mapping of Beta-offset indicator values to indexes in Table 9.3-2 of [5, TS38.213]

| Value of Beta_offset indicator | Beta_offset index in Table 9.3-2 of [5, TS38.213] |
|---|---|
| 00 | 1st index provided by higher layer parameter |
| | sl-BetaOffsets2ndSCI |
| 01 | 2nd index provided by higher layer parameter |
| | sl-BetaOffsets2ndSCI |
| 10 | 3rd index provided by higher layer parameter |
| | sl-BetaOffsets2ndSCI |
| 11 | 4th index provided by higher layer parameter |
| | sl-BetaOffsets2ndSCI |

Table 6 shows an example of a 2^{nd}-stage SCI format.

TABLE 6
3GPP TS 38.212
▪ SCI format 2-A
SCI format 2-A is used for the decoding of PSSCH,
with HARQ operation when HARQ-ACK
information includes ACK or NACK, when
HARQ-ACK information includes only NACK, or
when there is no feedback of HARQ-ACK information.
The following information is transmitted
by means of the SCI format 2-A:
- HARQ process number-4 bits as defined
in clause 16.4 of [5, TS 38.213].
- New data indicator-1 bit as defined in
clause 16.4 of [5, TS 38.213].
- Redundancy version-2 bits as defined in
clause 16.4 of [6, TS 38.214].
- Source ID-8 bits as defined in clause
8.1 of [6, TS 38.214].
- Destination ID-16 bits as defined in
clause 8.1 of [6, TS 38.214].
- HARQ feedback enabled/disabled indicator-
1 bit as defined in
clause 16.3 of [5, TS 38.213].
- Cast type indicator-2 bits as
defined in Table 8.4.1.1-1.
- CSI request-1 bit as defined in
clause 8.2.1 of [6, TS 38.214].
Table 8.4.1.1-1: Cast type indicator

| Value of Cast | |
|---|---|
| type indicator | Cast type |
| 00 | Broadcast |
| 01 | Groupcast |
| | when HARQ-ACK information includes |
| | ACK or NACK |
| 10 | Unicast |
| 11 | Groupcast |
| | when HARQ-ACK information includes |
| | only NACK |

▪ SCI format 2-B
SCI format 2-B is used for the decoding of PSSCH,
with HARQ operation when HARQ-ACK
information includes only NACK, or when
there is no feedback of HARQ-ACK information.
The following information is transmitted
by means of the SCI format 2-B:
- HARQ process number-4 bits as defined
in clause 16.4 of [5, TS 38.213].
- New data indicator-1 bit as defined in
clause 16.4 of [5, TS 38.213].
- Redundancy version-2 bits as defined in
clause 16.4 of [6, TS 38.214].
- Source ID-8 bits as defined in clause
8.1 of [6, TS 38.214].
- Destination ID-16 bits as defined in
clause 8.1 of [6, TS 38.214].
- HARQ feedback enabled/disabled
indicator-1 bit as
defined in clause 16.3 of [5, TS 38.213].
- Zone ID-12 bits as defined in clause
5.8.11 of [9, TS 38.331].
- Communication range requirement-
4 bits determined by higher
layer parameter sl-ZoneConfigMCR-Index.

Referring to FIGS. 9A and 9B, the first UE may receive the PSFCH based on Table 7. For example, the first UE and the second UE may determine a PSFCH resource based on Table 7, and the second UE may transmit HARQ feedback to the first UE using the PSFCH resource.

```
TABLE 7
3GPP TS 38.213
UE procedure for reporting HARQ-ACK on sidelink
A UE can be indicated by an SCI format scheduling a PSSCH reception, in one or more sub-
channels from a number of [symbol]    sub-channels, to transmit a PSFCH with HARQ-ACK
information in response to the PSSCH reception. The UE provides HARQ-ACK information
that includes ACK or NACK, or only NACK.
A UE can be provided, by sl-PSFCH-Period-r16, a number of slots in a resource pool for a
period of PSFCH transmission occasion resources. If the number is zero, PSFCH
transmissions from the UE in the resource pool are disabled.
A UE expects that a slot tₖ′^{SL} (0 ≤ k < Tₘₐₓ′) has a PSFCH transmission occasion resource if
k mod N_{PSSCH}^{PSFCH} = 0, where tₖ′^{SL} is defined in └6, TS 38.214┘, and Tₘₐₓ′ is a number of slots that
belong to the resource pool within 10240 msec according to [6. TS 38.214], and N_{PSSCH}^{PSFCH} is
provided by sl-PSFCH-Period-r16.
A UE may be indicated by higher layers to not transmit a PSFCH in response to a PSSCH
reception [11, TS 38.321].
If a UE receives a PSSCH in a resource pool and the HARQ feedback enabled/disabled
indicator field in an associated SCI format 2-A or a SCI format 2-B has value 1 |5, TS
38.212|, the UE provides the HARG-ACK information in a PSFCH transmission in the
resource pool. The UE transmits the PSFCH in a first slot that includes PSFCH resources
and is at least a number of slots, provided by sl-MinTimeGapPSFCH-r16, of the resource
pool after a last slot of the PSSCH reception.
A UE is provided by sl-PSFCH-RB-Set-r16 set of M_{PRB, set}^{PSFCH} PBRs in a resource pool for
PSFCH transmission in a PRB of the resource pool. For a number of N_{subch} sub-channels for
the resource pool, provided by sl-NumSubchannel, and a number of PSSCH slots associated
with a PSFCH slot that is less than or equal to N_{PSSCH}^{PSFCH}, the UE allocates the
[(i + j · N_{PSSCH}^{PSFCH}) · M_{subch, slot}^{PSFCH}, (i + 1 + j · N_{PSSCH}^{PSFCH}) · M_{subch, slot}^{PSFCH} − 1] PRBs from the M_{PRB, set}^{PSFCH}
PRBs to slot i among the PSSCH slots associated with the PSFCH slot and sub-channel j, where
M_{subch, slot}^{PSFCH} = M_{PRB, set}^{PSFCH}/(Nsubch · N_{PSSCH}^{PSFCH}), 0 ≤ i < N_{PSSCH}^{PSFCH}, 0 ≤ j < N_{subch}, and the allocation
starts in an ascending order of i and continues in an ascending order of j. The UE expects that
M_{PRB, set}^{PSFCH} is a multiple of N_{subch} · N_{PSSCH}^{PSFCH}.
A UE determines a number of PSFCH resources available for multiplexing HARQ-ACK
information in a PSFCH transmission as R_{PRB, CS}^{PSFCH} = [symbol]    · M_{subch, slot}^{PSFCH} · N_{CS}^{PSFCH} where N_{CS}^{PSFCH}
is a number of cyclic shift pairs for the resource pool and, based on an indication by higher
layers.
  - N_{type}^{PSFCH} = 1 and the M_{subch, slot}^{PSFCH} PRBs are associated with the starting sub-channel of the
  corresponding PSSCH
  - N_{type}^{PSFCH} N_{subch}^{PSSCH} and the N_{subch}^{PSSCH} · M_{subch, slot}^{PSFCH} PRBs are associated with one or more
  sub-channels from the N_{subch}^{PSSCB} sub-channels of the corresponding PSSCH
The PSFCH resources are first indexed according to an ascending order of the PRB index,
from the N_{type}^{PSFCH} · M_{subch,slot}^{PSFCH} PRBs, and then according to an ascending order of the cyclic
shift pair index from the N_{CS}^{PSFCH} cyclic shift pairs.
A UE determines an index of a PSFCH resource for a PSFCH transmission in response to a
PSSCH reception is (P_{ID} + M_{ID})mod_{PRB, CS}^{PSFCH} where P_{ID} is a physical layer source ID provided
by SCI format 2-A or 2-B [5, TS 38.212] scheduling the PSSCH reception, and M_{ID} is the
identity of the UE receiving the PSSCH as indicated by higher layers if the UE detects a SCI
format 2-A with Cast type indicator field value of ″01″; otherwise. M_{ID} is zero.
A UE determines a m₀ value, for computing a value of cyclic shift α [4, TS 38.211], from a
cyclic shift pair index corresponding to a PSFCH resource index and from N_{CS}^{PSFCH} using
Table 16.3-1
Table 16.3-1: Set of cyclic shift pairs
```

| | m₀ | | | | | |
|---|---|---|---|---|---|---|
| | Cyclic | Cyclic | Cyclic | Cyclic | Cyclic | Cyclic |
| | Shift Pair | Shift Pair | Shift Pair | Shift Pair | Shift Pair | Shift Pair |
| N_{CS}^{PSFCH} | Index 0 | Index 1 | Index 2 | Index 3 | Index 4 | Index 5 |
| 1 | 0 | — | — | — | — | — |
| 2 | 0 | 3 | — | — | — | — |
| 3 | 0 | 2 | 4 | — | — | — |
| 6 | 0 | 1 | 2 | 3 | 4 | 5 |

A UE determines a m_{CS} value, for computing a value of cyclic shift α [4, TS 38.211], as in
Table 16.3-2 if the UE detects a SCI format 2-A with Cast type indicator field value of ″01″
or ″10″. or as in Table 16.3-3 if the UE detects a SCI format 2-B or a SCI format 2-A with
Cast type indicator field value of ″11″. The UE applies one cyclic shift from a cyclic shift pair
to a sequence used for the PSFCH transmission [4, TS 38.211].
Table 16.3-2: Mapping of HARQ-ACK information bit values to a cyclic shift, from a cyclic
shift pair, of a sequence for a PSFCH transmission when HARQ-ACK information includes
ACK or NACK

| HARK-ACK Value | 0 (NACK) | 1 (ACK) |
|---|---|---|
| Sequence cyclic shift | 0 | 5 |

Table 16.3-3: Mapping of HARQ-ACK information bit values to a cyclic shift, from a cyclic
shift pair, of a sequence for a PSFCH transmission when HARQ-ACK information includes
only NACK

| HARK-ACK Value | 0 (NACK) | 1 (ACK) |
|---|---|---|
| Sequence cyclic shift | 0 | N/A |

[symbol]

indicates data missing or illegible when filed

Referring to FIG. 9A, the first UE may transmit SL HARQ feedback to the base station through the PUCCH and/or the PUSCH based on Table 8.

TABLE 8
3GPP TS 38.213
16.5 UE procedure for reporting HARQ-ACK on uplink
A UE can be provided PUCCH resources or PUSCH
resources [12, TS 38.331] to report
HARQ-ACK information that the UE generates
based on HARQ-ACK information that the UE
obtains from PSFCH receptions, or from absence
of PSFCH receptions. The UE reports
HARQ-ACK information on the primary cell of
the PUCCH group, as described in Clause 9,
of the cell where the UE monitors PDCCH for
detection of DCI format 3_0.
For SL configured grant Type 1 or Type 2 PSSCH
transmissions by a UE within a time period
provided by sl-PeriodCG, the UE
generates one HARQ-ACK
information bit in response to
the PSFCH receptions to multiplex in a PUCCH
transmission occasion that is after a last time
resource, in a set of time resources.
For PSSCH transmissions scheduled by a DCI
format 3_0, a UE generates HARQ-ACK
information in response to PSFCH receptions to
multiplex in a PUCCH transmission occasion
that is after a last time resource in a set of time
resources provided by the DCI format 3_0.
For each PSFCH reception occasion, from a
number of PSFCH reception occasions, the UE
generates HARQ-ACK information to report
in a PUCCH or PUSCH transmission. The UE
can be indicated by a SCI format to perform
one of the following and the UE constructs a
HARQ-ACK codeword with HARQ-ACK
information, when applicable
- if the UE receives a PSFCH associated with a
SCI format 2-A with Cast type indicator
field value of “10”
- generate HARQ-ACK information with
same value as a value of HARQ-ACK
information the UE determines from a PSFCH
reception in the PSFCH reception
occasion and, if the UE determines that a PSFCH is
not received at the PSFCH
reception occasion, generate NACK
- if the UE receives a PSFCH associated with a
SCI format 2-A with Cast type indicator
field value of “01”
- generate ACK if the UE determines ACK
from at least one PSFCH reception
occasion, from the number of PSFCH reception
occasions, in PSFCH resources
corresponding to every identity
M_{ID} of the UEs that the
UE expects to receive the
PSSCH, as described in Clause 16.3:
otherwise, generate NACK
- if the UE receives a PSFCH associated with a
SCI format 2-B or a SCI format 2-A with
Cast type indicator field value of “11”
- generate ACK when the UE determines absence of
PSFCH reception for each
PSFCH reception occasion from the number
of PSFCH reception occasions:
otherwise, generate NACK
After a UE transmits PSSCHs and receives PSFCHs
in corresponding PSFCH resource
occasions, the priority value of HARQ-ACK
information is same as the priority value of the
PSSCH transmissions that is associated with
the PSFCH reception occasions providing the
HARQ-ACK information.
The UE generates a NACK
when, due to prioritization,
as described in Clause 16.2.4, the UE
does not receive PSFCH in any
PSFCH reception occasion
associated with a PSSCH
transmission in a resource provided by a DCI
format 3_0 with CRC scrambled by a SL-RNTI
or, for a configured grant,
in a resource provided in
a single period and for which the UE is
provided a PUCCH resource to report HARQ-ACK
information. The priority value of the
NACK is same as the priority value
of the PSSCH transmission.
The UE generates a NACK
when, due to prioritization
as described in Clause 16.2.4, the UE
does not transmit a PSSCH in any of the resources
provided by a DCI format 3_0 with CRC
scrambled by SL-RNTI or, for a configured grant,
in any of the resources provided in a single
period and for which the UE is provided a PUCCH
resource to report HARQ-ACK information.
The priority value of the NACK
is same as the priority
value of the PSSCH that was not
transmitted due to prioritization.
The UE generates an ACK if the UE does not
transmit a PSCCH with a SCI format 1-A
scheduling a PSSCH in any of
the resources provided
by a configured grant in a single period
and for which the UE is provided a PUCCH resource
to report HARQ-ACK information. The
priority value of the ACK is same as the largest
priority value among the possible priority
values for the configured grant.
A UE does not expect to be provided PUCCH
resources or PUSCH resources to report
HARQ-ACK information that
start earlier than (N + 1) ·
(2048 + 144) · κ · 2^{μ} · T_{c} after the end
of a last symbol of a last
PSFCH reception occasion,
from a number of PSFCH reception
occasions that the UE generates HARQ-ACK
information to report in a PUCCH or PUSCH
transmission, where
- κ and T_{c} are defined in [4, TS 38.211]
- μ = min (μ_{SL}, μ_{UL}), where μ_{SL}
is the SCS configuration
of the SL BWP and μ_{UL} is the SCS
configuration of the active UL
BWP on the primary cell
- N is determined from μ according to Table 16.5-1
Table 16.5-1: Values of N

| μ | N |
|---|---|
| 0 | 14 |
| 1 | 18 |
| 2 | 28 |
| 3 | 32 |

With reference to slots for PUCCH transmissions
and for a number of PSFCH reception
occasions ending in slot n, the UE provides the
generated HARQ-ACK information in a
PUCCH transmission within slot n + k, subject to
the overlapping conditions in Clause 9.2.5,
where k is a number of slots
indicated by a PSFCH-to-
HARQ_feedback timing indicator
field, if present, in a DCI format
indicating a slot for PUCCH
transmission to report the HARQ-
ACK information, or k is provided
by sl-PSFCH-ToPUCCH-
CG-Type1-r16. k = 0
corresponds to a last slot for
a PUCCH transmission
that would overlap with the last PSFCH
reception occasion assuming
that the start of the sidelink
frame is same as the start of the
downlink frame [4, TS 38.211].
For a PSSCH transmission by a
UE that is scheduled by a
DCI format, or for a SL configured
grant Type 2 PSSCH transmission activated by a DCI
format, the DCI format indicates to the
UE that a PUCCH resource is not
provided when a value
of the PUCCH resource indicator
field is zero and a value of
PSFCH-to-HARQ feedback
timing indicator field, if present, is
zero. For a SL configured grant
Type 1 PSSCH transmission,
a PUCCH resource can be
provided by sl-N1PUCCH-AN-r16 and sl-PSFCH-
TuPUCCH-CG-Type1-r16. If a PUCCH
resource is not provided,
the UE does not transmit a
PUCCH with generated HARQ-ACK
information from PSFCH reception occasions.
For a PUCCH transmission with
HARQ-ACK information,
a UE determines a PUCCH resource
after determining a set of PUCCH resources for
O_{UCI} HARQ-ACK information bits, as
described in Clause 9.2.1. The PUCCH resource
determination is based on a PUCCH resource
indicator field [5, TS 38.212]
in a last DCI format 3_0,
among the DCI formats 3_0 that have
a value of a PSFCH-to-
HARQ_feedback timing indicator
field indicating a same slot for the
PUCCH transmission, that the UE
detects and for which the
UE transmits corresponding
HARQ-ACK information in the PUCCH where,
for PUCCH resource determination, detected
DCI formats are indexed in an
ascending order across
PDCCH monitoring occasion indexes.
A UE does not expect to multiplex
HARQ-ACK information
for more that one SL configured
grants in a same PUCCH.
A priority value of a PUCCH transmission with one
or more sidelink HARQ-ACK information
bits is the smallest priority
value for the one or more
HARQ-ACK information bits.
In the following, the CRC for DCI
format 3_0 is scrambled
with a SL-RNTI or a SL-CS-RNTI.

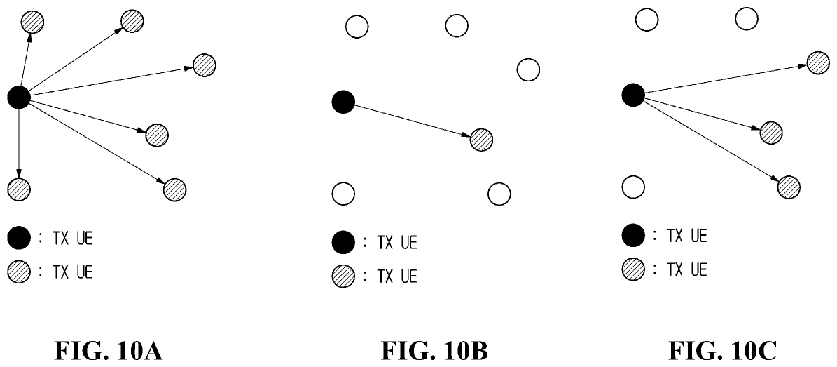

FIGS. 10A to 10C illustrate three cast types applicable to the present disclosure. The embodiment of FIGS. 10A to 10C may be combined with various embodiments of the present disclosure.

Specifically, FIG. 10A exemplifies broadcast-type SL communication, FIG. 10B exemplifies unicast type-SL communication, and FIG. 10C exemplifies groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

### Specific Embodiments of the Present Disclosure

The present disclosure relates to relay communication in a wireless communication system and, more particularly, to a method and device for performing sidelink-based relay communication. Specifically, the present disclosure relates to a technique for temporarily performing relay communication according to a change of a channel environment during sidelink communication.

As vehicle-related applications like autonomous driving require high-capacity data transmission, communication at mmWave bands is needed. Beamforming may be used to compensate for high path loss at mm-waves. In case of communication through beamforming, when a line-of-sight (LOS) path is blocked, communication may become impossible. For example, in case a vehicle turns at an intersection or another vehicle cuts in between vehicles communicating with each other, an LOS path may be blocked. The current standard defines relay communication for expanding network coverage. However, as for mmWave communication, it considers no relay communication applicable to a case of performing communication using a beam. Accordingly, for various situations in which an LOS path is blocked, the present disclosure proposes a technique of maintaining communication between terminals through relay communication using a terminal in another vehicle or a neighboring road side unit (RSU).

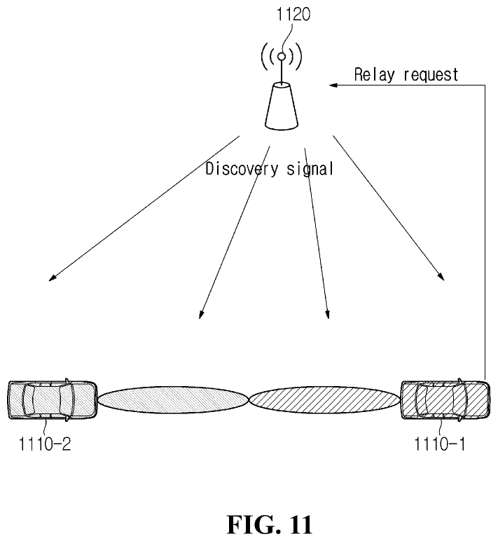

FIG. 11 illustrates a concept of relay communication based on a sidelink in a wireless communication system according to an embodiment of the present disclosure. Referring to FIG. 11, a first terminal 1110-1 and a second terminal 1110-2 perform direct communication by using directional beams. Herein, as a concept distinct from relay communication, direct communication means communication of signals between two objects through a physical channel without any other device in between. Herein, direct communication may be based on a sidelink. Herein, the first terminal 1110-1 transmits a signal by using a transmit beam, and the second terminal 1110-2 receives a signal by using a receive beam. Alternatively, the second terminal 1110-2 transmits a signal by using a transmit beam, and the first terminal 1110-1 receives a signal by using a receive beam. Herein, the first terminal 1110-1 and the second terminal 1110-2 are terminals in a vehicle and may perform communication while moving.

During direct communication using beamforming, when a path formed by a pair of beams between the first terminal 1110-1 and the second terminal 1110-2 is blocked, the communication may be interrupted. For example, the path may be blocked because of the emergence of an obstacle, a change in a relative position relation between the first terminal 1110-1 and the second terminal 1110-2, and the like. At this time, in case there is a neighboring relay device 1120 (e.g., another terminal, a RSU, etc.) that supports a relay service, the first terminal 1110-1 and the second terminal 1110-2 may continue communication by using the relay service provided by the relay device 1120. To this end, the relay device 1120 may transmit a discovery signal including information for informing provision of the relay service.

That is, according to various embodiments, while the first terminal 1110-1 and the second terminal 1110-2 set a sidelink connection between them and perform communication, if a path between the first terminal 1110-1 and the second terminal 1110-2 is predicted to be blocked due to occurrence of an obstacle and a neighboring device (e.g., relay device 1120) capable of providing a relay service is discovered, the first terminal 1110-1 and the second terminal 1110-2 may switch to relay communication. Herein, the relay communication may be based on a sidelink or an uplink and a downlink. At this time, path blocking may be predicted based on various scenarios. For example, when the first terminal 1110-1 and the second terminal 1110-2 are running in a same direction, if a preceding vehicle changes its running direction, a relative position relation is changed, and a nearby feature may block a path accordingly. In this case, if it is possible to identify the approach to a region (e.g., intersection) causing a change of running direction, the occurrence of an obstacle may be predicted. As another example, when another vehicle cuts in line between the first terminal 1110-1 and the second terminal 1110-2, the cutting-in vehicle may block the path as an obstacle. In this case, if a relative position to the another vehicle can be identified, the occurrence of an obstacle may be predicted.

According to various embodiments, in a situation where there is a neighboring device (e.g., relay device 1120) capable of providing a relay service, when the first terminal 1110-1 predicts path blocking, the first terminal 1110-1 may request a relay service to the relay device 1120, and the relay device 1120 may provide the relay service in response to the request of the first terminal 1110-1. Then, when an obstacle disappears, the relay service may be stopped according to a request of the first terminal 1110-1 or the second terminal 1110-2 or according to a determination of the relay device 1120. That is, the relay service may be temporary.

As a relay service is temporary, direct communication may be resumed. Accordingly, while relay communication is being performed, a configuration for direct communication between the first terminal 1110-1 and the second terminal 1110-2 may not be discarded, and the connection may keep valid. However, since a sidelink for direct communication cannot provide satisfactory quality due to path blocking, it may be treated as a temporary state of no data transmission (e.g., sleep state or idle state), and a direct communication link and a relay link may be understood to temporarily exist together.

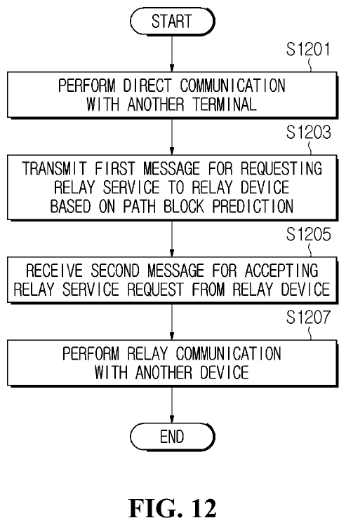

FIG. 12 illustrates an example of a method performed by a terminal requesting relay communication in a wireless communication system according to an embodiment of the present disclosure. FIG. 12 exemplifies an operation method of a terminal (e.g., first terminal 1110-1) that predicts path blocking.

Referring to FIG. 12, at step S1201, the terminal performs direct communication with another terminal. To this end, the terminal may perform operations like discovery signal transmission/reception, beam alignment and connection setting with the another terminal. That is, the terminal may perform sidelink communication with the another terminal by using a pair of beams that are determined through a beam alignment operation. The pair of beams determined by beam alignment configure a path for direct communication.

At step S1203, as the terminal predicts path blocking, the terminal transmits a first message for requesting a relay service to a relay device. Herein, the relay device is a device capable of providing a relay service, and the terminal may discover the relay device by using a signal (e.g., discovery signal) that is broadcast from the relay device. That is, in case the relay device is discovered and an obstacle is predicted to occur within a specified time, or in case an obstacle is predicted to occur and the relay device is discovered within a specified time, the terminal may request the relay service. Herein, the first message may include information on the terminal and information on the another terminal.

At step S1205, the terminal receives a second message for accepting the request for the relay service from the relay device. The second message may include information associated with a resource that is allocated for the relay service. In response to the request of the terminal, the resource for the relay service is allocated by the relay device, and information on the allocated resource may be received. Herein, the resource includes at least one of a resource allocated for beam alignment and a resource allocated for data relay. According to an embodiment, in case the relay service is based on a sidelink, the resource for the relay service may include a resource pool. Thus, the terminal may identify a resource pool or a resource which is allocated for transmitting or receiving data to or from the relay device.

At step S1207, the terminal performs relay communication with the another device. In other words, the terminal performs communication with the another device based on the relay service of the relay device. The relay communication may continue until sidelink communication by an existing pair of beams (e.g., the pair of beams used at step S1201) or a new pair of beams becomes possible.

According to the embodiment described with reference to FIG. 12, a terminal may perform relay communication. For communication between a terminal and a relay device, a beam alignment operation may be performed between the terminal and the relay device. According to an embodiment, beam alignment may be made by a discovery signal transmitted by the relay device and a first message transmitted by the terminal. That is, in case the discovery signal is beam-swept using a plurality of transmit beams, the terminal may notify an optimal transmit beam to the relay device by transmitting a first message through a resource corresponding to a transmit beam used at a time of receiving the discovery signal. In addition, in case the first message is beam-swept, the relay device may notify an optimal transmit beam to the terminal by transmitting a second message through a resource corresponding to a transmit beam used at a time of receiving the first message.

According to another embodiment, a separate resource for beam alignment may be allocated. For example, a terminal may receive information on a resource allocated for beam alignment from a relay device through a second message or a separate message and perform a beam alignment operation with the relay device by using the allocated resource. According to various embodiments, information thus received may include information associated with at least one of a resource allocated for beam alignment between a terminal and a relay device and a resource allocated for beam alignment between another terminal and the relay device. Specifically, a terminal and a relay device may beam sweep signals (e.g., reference signals) during a section allocated for beam alignment and feed an indicator for an optimal beam back, thereby determining a pair of beams for relay communication.

In addition, according to another embodiment, although not illustrated in FIG. 12, a terminal may transmit, to another terminal, a message for informing that relay communication will be performed. For example, after transmitting a first message, after receiving a second message, or after receiving a message including information associated with a resource for the beam alignment, a terminal may inform another terminal that relay communication will be performed. In this case, without signaling between the another device and the relay device, relay communication may start. Herein, according to an embodiment, in case the second message includes information associated with a resource allocated for beam alignment between the relay device and the another terminal, the terminal may transmit, to the another terminal, the information associated with the resource allocated for beam alignment between the relay device and the another terminal.

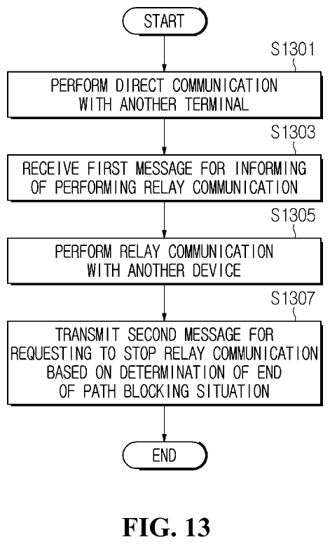

FIG. 13 illustrates an example of a method performed by a terminal participating in relay communication in a wireless communication system according to an embodiment of the present disclosure. FIG. 13 exemplifies an operation method of a counterpart terminal (e.g., second terminal 1110-2) of a terminal that predicts path blocking.

Referring to FIG. 13, at step S1301, a terminal performs direct communication with another terminal. To this end, the terminal may perform operations like discovery signal transmission/reception, beam alignment and connection setting with the another terminal. That is, the terminal may perform sidelink-based direct communication with the another terminal by using a pair of beams that are determined through a beam alignment operation.

At step S1303, the terminal receives a first message for informing of performing relay communication. The first message may be received from a relay device or another terminal. According to an embodiment, the first message may include information associated with a resource that is allocated for a relay service. For example, in case the relay service is based on a sidelink, the resource for the relay service may include a resource pool. According to another embodiment, a resource pool allocated for the relay service may be identical with a resource pool for sidelink communication with another device. In this case, information associated with a resource may not be included in the first message.

At step S1305, the terminal performs relay communication with the another device. In other words, the terminal performs communication with the another device based on the relay service of the relay device. The relay communication may continue until direct communication by an existing pair of beams (e.g., the pair of beams used at step S1301) or a new pair of beams becomes possible.

At step S1307, the terminal transmits a second message for requesting to stop the relay communication, as the terminal detects the termination of path blocking situation. That is, the terminal may detect a link blocking situation with another terminal and request the relay device or another device to stop the relay communication. For example, the terminal may determine the termination of the path blocking situation based on at least one of a quality change of a relay link, whether or not direct communication is possible, a direction of a beam used for the relay communication, and positions of the terminal and the another terminal. Herein, whether or not direct communication is possible may be determined based on a quality (e.g., RSRP, SNR, etc.) of a direct link with the another terminal.

In the embodiment described with reference to FIG. 13, a terminal may determine the termination of a path blocking situation and request to stop relay communication. However, according to another embodiment, the termination of a path blocking situation may be determined not by the terminal but by another terminal or a relay device. In this case, the determination of the another terminal or the relay device may be delivered to the terminal, and then the terminal may request to stop the relay communication. Alternatively, the another terminal or the relay device, which determines the termination of the path blocking situation, may request or notify to stop the relay communication.

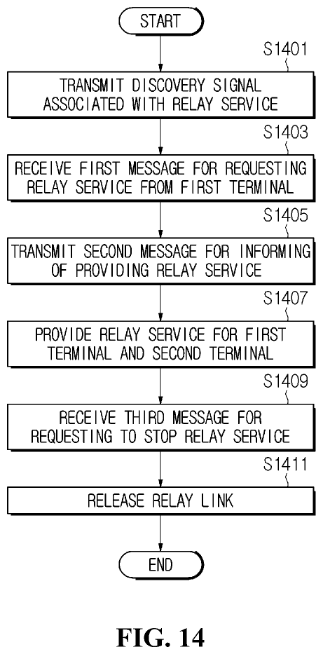

FIG. 14 illustrates an example of a method performed by a relay device in a wireless communication system according to an embodiment of the present disclosure. FIG. 14 exemplifies a method of operating a device (e.g., relay device 1120) that provides a relay service.

At step S1401, a relay device transmits a discovery signal associated with a relay service. The discovery signal may be transmitted either periodically or based on an event. The discovery signal may be broadcast to enable adjacent terminals to discover the relay device and include at least one of identification information of the relay device, information that the relay device provides a relay service, and a reference signal. Herein, the discovery signal may be beamformed and be transmitted using a plurality of transmit beams.

At step S1403, the relay device receives a first message for requesting a relay service from a first terminal. The first message may include information on the first terminal and information on a second terminal that performs direct communication with the first terminal. Herein, information on a terminal may include at least one of identification information, information on a resource for direct communication, and information on a beam used for direct communication.

At step S1405, the relay device transmits a second message for informing of providing the relay service. When receiving the first message, the relay device determines whether or not to provide a relay service and informs that the relay service will be provided. For example, the relay device may determine whether or not to provide a relay service, based on at least one of a distance to the first terminal, a distance to the second terminal, a channel quality to the first terminal, and a load state of the relay device. Herein, the second message may include information on a resource that is allocated for the relay service. Herein, the resource may include a resource that is allocated for configuring or providing the relay service. For example, the resource includes at least one of a resource allocated for beam alignment and a resource allocated for data relay.

At step S1407, the relay device provides the relay service for the first terminal and the second terminal. That is, the relay device delivers data between the first terminal and the second terminal through a relay link. In other words, the relay device transmits data received from the first terminal to the second terminal and transmits data received from the second terminal to the first terminal. To this end, although not illustrated in FIG. 14, the relay device may perform at least one of a beam alignment operation, a scheduling operation, and a connection setting operation. Herein, the relay device may set connections with the first terminal and the second terminal respectively based on information included in the first message.

At step S1409, the relay device receives a third message for requesting to stop the relay service. That is, the relay device may receive the third message for notifying that the relay service is not necessary. In other words, the relay device may receive the third message for notifying that the first terminal and the second terminal will perform direct communication. The third message may be received from the first terminal or the second terminal.

At step S1411, the relay device releases the relay link. The third message informs that the first terminal and the second terminal will recover direct communication. Accordingly, even when receiving from one of the first terminal and the second terminal, the relay device may release all the relay links with the first terminal and the second terminal.

As in the embodiment described with reference to FIG. 14, a relay device may provide a relay service. Herein, the relay device may also apply beamforming, and in this case, the relay device may perform a beam alignment operation with a first terminal and a second terminal. According to an embodiment, a relay device may perform a beam alignment operation by using a discovery signal, a first message received from a first terminal, and a second message. Alternatively, according to another embodiment, a relay device may allocate a separate resource for beam alignment and perform a beam alignment operation by using a reference signal in the allocated resource.

According to an embodiment, beam alignment with a second terminal may be performed by using information on a second terminal, which is obtained through a first message. That is, a beam for a first terminal may be determined by performing beam alignment with a first terminal, and when a relative direction from the first terminal to a second terminal is identified based on information obtained through a first message, a relay device may determine a beam for the second terminal without a beam measurement. However, according to another embodiment, beam alignment of a relay device and a second terminal may be performed based on a beam measurement, and in this case, the relay device may deliver information associated with the beam alignment of the relay device and the second terminal through a second message.

In the embodiment described with reference to FIG. 14, a relay device receives a message for requesting to stop a relay service from a first terminal or a second terminal. However, according to another embodiment, whether or not to stop a relay service may be determined by a relay device. For example, a relay device may determine the end of a path blocking situation based on at least one of a quality change of a relay link, directions of beams used for relay communication, and positions of a first terminal and a second terminal. In this case, a message regarding the stop of a relay service may be transmitted from the relay device to at least one of the first terminal and the second terminal.

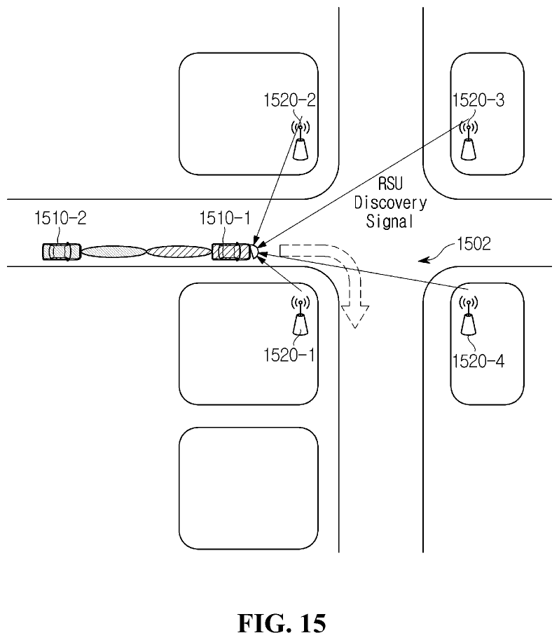

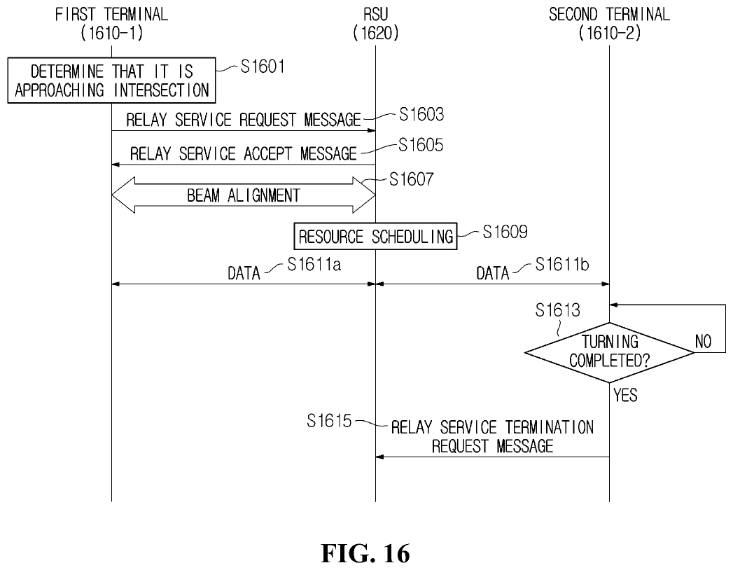

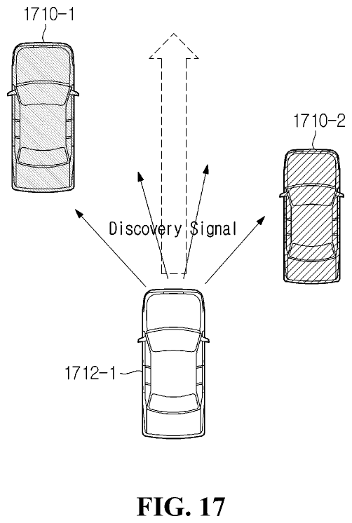

According to the above-described various embodiments, relay communication may be utilized to prepare for blocking of a path used for direct communication. In various situations where a path is blocked, the above-described embodiments may be applied. However, at least some of the embodiments may be modified according to particular situations. Hereinafter will be described examples of scenarios to which various embodiments are applicable. Specifically, an intersection scenario will be described with reference to FIG. 15 and FIG. 16, and a scenario of a cutting-in vehicle will be described with reference to FIG. 17.

FIG. 15 illustrates an example of a scenario in which relay communication is performed by turning at an intersection in a wireless communication system according to an embodiment of the present disclosure. Referring to FIG. 15, while a first terminal 1510-1 included in a preceding vehicle and a second terminal 1510-2 included in a following vehicle perform direct communication by using the beamforming technology, they enter an intersection 1502. In a situation where the first terminal 1510-1 and the second terminal 1510-2 perform direct communication by using mmWave beams, when the preceding vehicle turns at the intersection 1502 first, the line of sight (LOS) between the two terminals 1510-1 and 1510-2 may be blocked by a building and the like near the intersection 1502, and the communication may be interrupted.

In case RSUs 1520-1 to 1520-4 near the intersection provide a relay function in this situation, an application between the two terminals 1510-1 and 1510-2 may keep working without interruption of communication. To this end, the preceding vehicle recognizes its getting closer to the intersection 1502, predicts the vehicle's turning, and then requests a relay service to one of the RSUs 1520-1 to 1520-4. By broadcasting a discovery signal, the RSUs 1520-1 to 1520-4 may inform vehicles or terminals, which are getting closer to the intersection 1502, of their existence, a service provided by the RSUs (e.g., relay service), and a resource for requesting a service.

FIG. 16 illustrates an example of a procedure for relay communication by turning at an intersection in a wireless communication system according to an embodiment of the present disclosure. FIG. 16 is a procedure associated with relay communication in a situation as shown in FIG. 15, and in the procedure thus exemplified, a RSU 1620 performs relay communication when a first terminal 1610-1 is included in a preceding vehicle and a second terminal 1610-2 is included in a following vehicle.

Referring to FIG. 16, at step S1601, the first terminal 1610-1 determines that an intersection is getting closer. That is, the first terminal 1610-1 recognizes that relay communication should start as a preceding vehicle approaches an intersection. Herein, the approach to the intersection may be predicted by the first terminal 1610-1 or be predicted by another device in a vehicle and be notified to the first terminal 1610-1. For example, the approach to the intersection may be recognized based on a location of a vehicle or be recognized by detecting a discovery signal that is transmitted from a RSU installed at the intersection. In addition, turning at the intersection may be predicted based on path information set in a navigation system, a movement of a steering wheel, an operation of a turn signal, and a speed change.

At step S1603, the first terminal 1610-1 transmits a relay service request message to a RSU 1620. Herein, the RSU 1620, to which relay is to be requested, may be selected based on at least one of a location of a RSU, service information of a RSU in a discovery signal, a RSRP value for a discovery signal, and an RSU ID. In addition, the relay service request message may include at least one of a source/destination ID, a RSU ID, a service ID, security information, and a sequence number. Additionally, the relay service request message may include information associated with the first terminal 1610-1 and the second terminal 1610-2. For example, the information associated with the first terminal 1610-1 and the second terminal 1610-2 may include at least one of a terminal ID, a location of a terminal, a moving speed of a terminal, resource information used by a terminal for direct communication, resource information available to a terminal, security information of a terminal, and information on a beam used for direct communication. Since the first terminal 1610-1 and the second terminal 1610-2 already perform communication using a direct path, the first terminal 1610-1 may already have or easily obtain the above-described information. Using information provided through the relay service request message, the RSU 1620 may prepare a connection setup with the second terminal 1610-2 in advance without communication with the second terminal 1610-2.

At step S1605, the RSU 1620 transmits a relay service accept message to the first terminal 1610-1. The first terminal 1610-1 may deliver the relay service accept message or transmit a separate message for notifying the acceptance of a relay service to the second terminal 1610-2. Accordingly, the second terminal 1610-2 may confirm that the relay service request is accepted, without signaling with the RSU 1620. The relay service accept message may include information associated with a resource for beam alignment.

At step S1607, the first terminal 1610-1 and the RSU 1620 perform beam alignment. To this end, the first terminal 1610-1 and the RSU 1620 may perform beam sweeping of a signal for selecting a beam and notify a beam selection result. Herein, a direction range of beam sweeping may be selected based on a direction of a receive beam used at a time when the first terminal 1610-1 receives a discovery signal of the RSU 1620. When a beam alignment operation between the RSU 1620 and the first terminal 1610-1 is completed, the RSU may select a beam for the second terminal 1610-2 based on information on a beam, which has been identified through beam alignment, and position information of the second terminal 1610-2 relative to the first terminal 1610-1.

At step S1609, the RSU 1620 schedules a resource. In other words, the RSU 1620 may schedule a resource for a relay service. For example, the RSU 1620 may select a resource pool for a relay service. Herein, a resource pool for communication with the first terminal 1610-1 and a resource pool for communication with the second terminal 1610-2 may be identical with each other or be different from each other. According to an embodiment, the RSU 1620 may select a resource pool used for direct communication between the first terminal 1610-1 and the second terminal 1610-2 as a resource pool for a relay service.

At steps S1611a and S1611b, the RSU 1620 relays data between the first terminal 1610-1 and the second terminal 1610-2. The RSU 1620 may transmit data, which is received from the first terminal 1610-1 through a first relay link, to the second terminal 1610-2 through a second relay link or transmit data, which is received from the second terminal 1610-2 through the second relay link, to the first terminal 1610-1 through the first relay link. Relay communication using a relay link may start when the relay link is available or when a direct path between the first terminal 1610-1 and the second terminal 1610-2 is blocked.

At step S1613, the second terminal 1610-2 determines whether or not turning at the intersection is completed. For example, the second terminal 1610-2 may determine whether or not turning is completed, based on at least one of a location of a following vehicle, a travel direction of the following vehicle, and availability of the direct path between the first terminal 1610-1 and the second terminal 1610-2. In order to determine the availability of a direct path, during relay communication, the first terminal 1610-1 may transmit a discovery signal for monitoring the direct path. In this case, the second terminal 1610-2 may determine whether or not the direct path is available, by attempting to detect the discovery signal.

When the turning is completed, at step S1615, the second terminal 1610-2 transmits a relay service termination request message to the RSU 1620. Accordingly, the relay service is terminated, and the first terminal 1610-1 and the second terminal 1610-2 may recover the direct path and perform direct communication.

Like the embodiments described with reference to FIG. 15 and FIG. 16, in case a direct communication path between two vehicles is blocked in an intersection turning situation, a relay link may be formed by using RSUs near an intersection. Thus, when two vehicles perform direct communication, a preceding vehicle may detect/predict occurrence of path blocking and request a relay service to a RSU. At this time, a terminal included in the preceding vehicle may provide not only its own information but also information on a terminal included in a following vehicle so that the relay link can be formed quickly and efficiently.

FIG. 17 illustrates an example of a scenario in which relay communication is performed by another vehicle's cutting in line in a wireless communication system according to an embodiment of the present disclosure. Referring to FIG. 17, while a first terminal 1710-1 and a second terminal 1710-2, which are included in two vehicles running in a same direction respectively, perform sidelink communication by using a beamforming technique, a vehicle including a third terminal 1712-1 cuts in between the first terminal 1710-1 and the second terminal 1710-2. Accordingly, the vehicle including the third terminal 1712-1 may block a line of sight between the two terminals 1710-1 and 1710-2, and communication may be interrupted.

At this time, the third terminal 1712-1 may provide a relay service and broadcast a discovery signal including information for notifying the availability of the relay service. Accordingly, through the discovery signal, the first terminal 1710-1 may confirm that the third terminal 1712-1 has a relay function, and the first terminal 1710-1 may perform relay communication with the second terminal 1710-2 through the third terminal 1712-1. In order to discover the third terminal 1712-1 and detect its cutting-in, the first terminal 1710-1 may attempt to detect a signal of other neighboring terminals by using other beams within a specified range from a beam for communication with the second terminal 1710-2. The reason for this is as follows. When a signal of a new terminal is discovered by using another beam within a specified angle with the beam for communication with the second terminal 1710-2 and an angle gradually decreases between a beam direction, in which the discovered signal of the terminal is received, and a beam direction for the current communication, a vehicle including the discovered terminal may be predicted to block the link formed for communication between the first terminal 1710-1 and the second terminal 1710-2.

The above-described embodiments relate to a case in which two terminals, which have performed direct communication, perform relay communication to prepare for link blocking. At this time, the relay communication may be temporary and terminate when the direct communication becomes possible. As the relay communication terminates, the direct communication may be performed again, and the termination of the relay communication may be determined by one of two terminals performing direct communication or by a third device (e.g., RSU, terminal) providing a relay service. Hereinafter, embodiments for determining termination of relay communication will be described.

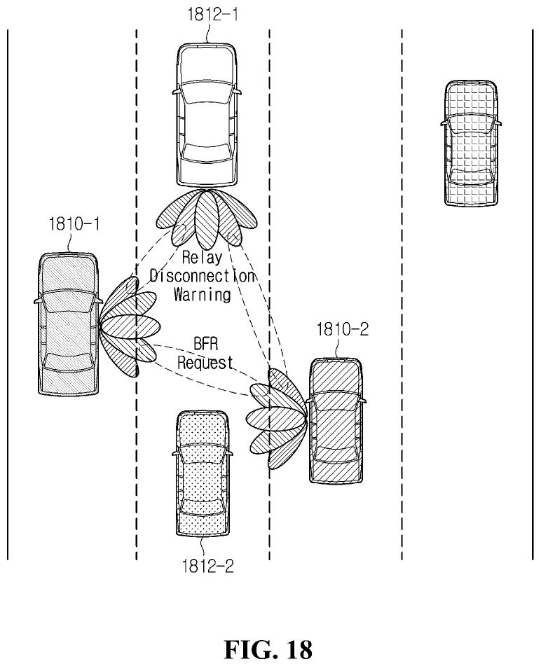

FIG. 18 illustrates an example of a scenario in which relay communication is terminated in a wireless communication system according to an embodiment of the present disclosure. Referring to FIG. 18, a first terminal 1810-1 and a second terminal 1810-2 perform mmWave sidelink relay communication through a relay terminal 1812-1. When the relay terminal 1812-1 becomes distant from the first terminal 1810-1 and the second terminal 1810-2, the quality of a relay link is lowered, and the first terminal 1810-1 and the second terminal 1801-2 should find a new relay device.

Generally, the connection quality of a relay link may be determined based on a RSRP that is measured using a reference signal. Although the measurement of RSRP enables a numerical quality value to be obtained, it is necessary to use a resource for transmitting a reference signal and the computing power of a receiver for calculating connection quality. In order to solve this disadvantage, the present disclosure proposes a method of using an angle between a beam forming a relay connection and a running direction of the relay terminal 1812-1. When using information on a lane in which the first terminal 1810-1 and the second terminal 1810-2 are located, a width of the lane, and an angle between beams and a running direction of the relay terminal 1812-1, which can be inferred from a beam index forming a relay connection, distances between the relay terminal 1812-1 and the first terminal 1810-1 and the second terminal 1810-2 respectively may be inferred, and the quality of the relay connection may be indirectly predicted based on the distances thus inferred. In case the quality thus predicted is below a specific reference value, the relay terminal 1812-1 may inform it to the first terminal 1810-1 and the second terminal 1810-2 at each end of the relay link, and the first terminal 1810-1 and the second terminal 1810-2 may retrieve a new relay device (e.g., relay terminal 1812-1) or attempt to recover direct connection accordingly.

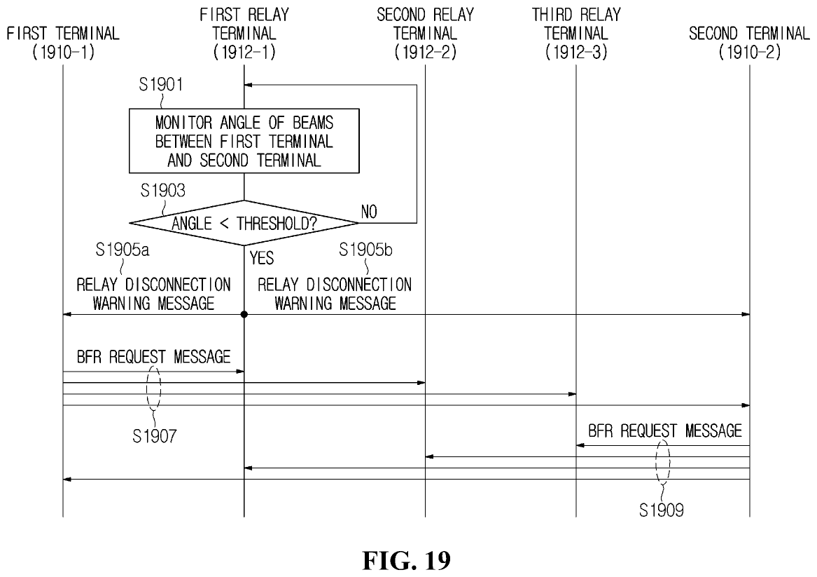

FIG. 19 illustrates an example of a procedure for terminating relay communication based on an angle between beams in a wireless communication system according to an embodiment of the present disclosure. FIG. 19 is a procedure associated with termination of relay communication in a same situation as shown in FIG. 18, and in a case exemplified herein, a first terminal 1910-1 and a second terminal 1910-2 perform relay communication through a relay terminal 1912-1.

Referring to FIG. 19, at step S1901, a first relay terminal 1812-1 monitors an angle of beams between the first terminal 1910-1 and the second terminal 1910-2. In other words, while a second relay terminal 1912-1 is being connected to the first terminal 1910-1 and the second terminal 1910-2 and relay communication is being performed, the second relay terminal 1912-1 monitors an angle between a beam connected to the first terminal 1910-1 and a beam connected to the second terminal 1910-2. Beam indexes used for communication with the first terminal 1910-1 and the second terminal 1910-2 may be converted to an angle between beams.

At step S1903, the second relay terminal 1912-1 determines whether or not the angle is smaller than a threshold. When the angle is smaller than the threshold, at steps S1905a and 51905b, the second relay terminal 1912-1 transmits a relay disconnection warning message to the first terminal 1910-1 and the second terminal 1910-2 respectively. The relay disconnection warning message may include information on a beam from a location of the first terminal 1910-1 toward the second terminal 1910-2 and a beam from a location of the second terminal 1910-2 toward the first terminal 1910-1, which are determined based on information associated with beams used between the first terminal 1910-1 and the second relay terminal 1912-1 and between the second terminal 1910-2 and the second relay terminal 1912-1.

At step S1907, the first terminal 1910-1 transmits a beam failure recovery (BFR) request message. At step S1909, the second terminal 1910-2 transmits a beam failure recovery request message. At this time, in case the first terminal 1910-1 and the second terminal 1910-2 receives a beam failure recovery request message from each other, the first terminal 1910-1 and the second terminal 1910-2 may perform a beam failure recovery process. Alternatively, in case another relay terminal 1912-2 or 1912-3 other than the second relay terminal 1912-1 receives a beam failure recovery message, the another relay terminal 1912-2 or 1912-3 may transmit a relay suggestion by using a beam failure recovery response resource and a signal structure.

Referring to FIG. 18 and FIG. 19, embodiments have been described in which relay communication is terminated based on an angle between two beams used for a relay service in a relay terminal. An embodiment of using an angle between beams may be applied to other embodiments described above. For example, an operation of determining termination of relay communication based on an angle between beams may be applied to the embodiment described with reference to FIG. 15 and FIG. 16.

In a situation of turning at an intersection, a terminal including a following vehicle determines the completion of turning and transmits a relay termination request message. Herein, the completion of turning may be determined based on a physical movement of a vehicle. Alternatively, the completion of turning may also be determined based on an angle between beams. That is, a RSU, which provides a relay service near an intersection, may monitor a change of angle between a first beam toward a first terminal and a second beam toward a second terminal, when the angle between the beams is below a threshold, determine that vehicles including the two terminals have completely turned, and notify this to the first terminal or the second terminal. Alternatively, without notification about the completion of turning, a RSU may notify a relay termination request message to the first terminal or the second terminal.

System and Various Devices to which Embodiments of the Present Disclosure are Applicable

Various embodiments of the present disclosure may be combined with each other.

Hereinafter, a device to which various embodiments of the present disclosure may be applied will be described. Although not limited thereto, various descriptions, functions, procedures, proposals, methods, and/or operation flowcharts disclosed in this document may be applied to various fields requiring wireless communication/connection (e.g., 5G) between devices.

Hereinafter, it will be described in more detail with reference to the drawings. In the following drawings/description, the same reference numerals may represent the same or corresponding hardware blocks, software blocks, or functional blocks, unless otherwise indicated.

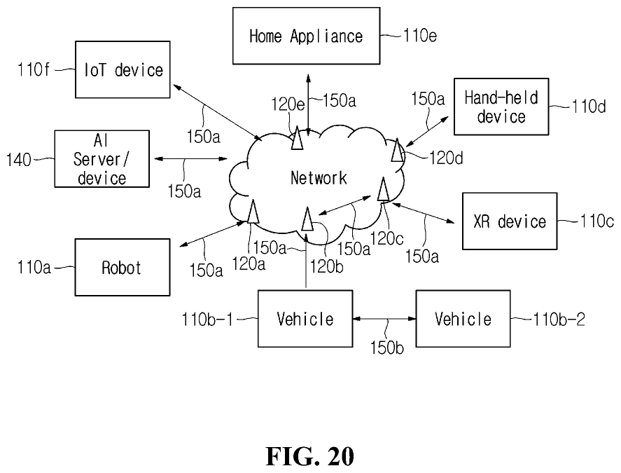

FIG. 20 illustrates a communication system, in accordance with an embodiment of the present disclosure. The embodiment of FIG. 20 may be combined with various embodiments of the present disclosure.

Referring to FIG. 20, the communication system applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include at least one of a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120a to 120e network may be implemented by a wireless device, and a specific wireless device 120a may operate as a base station/network node for another wireless device.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names

The wireless devices 100a to 100f may be connected to the network through the base station 120. AI technology is applicable to the wireless devices 100a to 100f, and the wireless devices 100a to 100f may be connected to the AI server 100g through the network. The network may be configured using a 3G network, a 4G (e.g., LTE) network or a 5G (e.g., NR) network, etc. The wireless devices 100a to 100f may communicate with each other through the base stations 120a to 120e or perform direct communication (e.g., sidelink communication) without through the base stations 120a to 120e. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to Wireless communications/connections 150a, 150b and 150c may be established between the wireless devices 100a to 100f/the base stations 120a to 120e and the base stations 120a to 120e/the base stations 120a to 120e. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

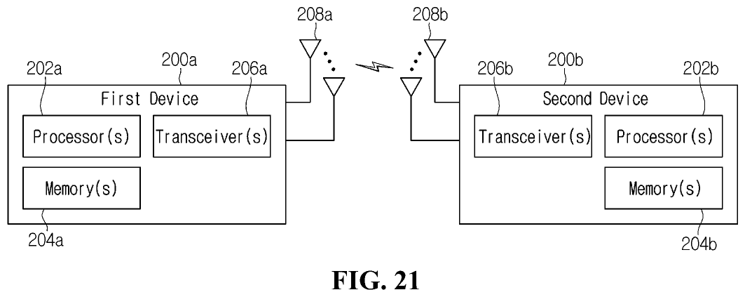

FIG. 21 illustrates wireless devices, in accordance with an embodiment of the present disclosure. The embodiment of FIG. 21 may be combined with various embodiments of the present disclosure.

Referring to FIG. 21, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 20.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may perform wireless communications with the first wireless device 200a and may include one or more processors 202b and one or more memories 204b and may further include one or more transceivers 206b and/or one or more antennas 208b. The functions of the one or more processors 202b, one or more memories 204b, one or more transceivers 206b, and/or one or more antennas 208b are similar to those of one or more processors 202a, one or more memories 204a, one or more transceivers 206a and/or one or more antennas 208a of the first wireless device 200a.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs), one or more service data unit (SDU), messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. In addition, one or more transceivers 206a and 206b may be coupled with one or more antennas 208a and 208b, and may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

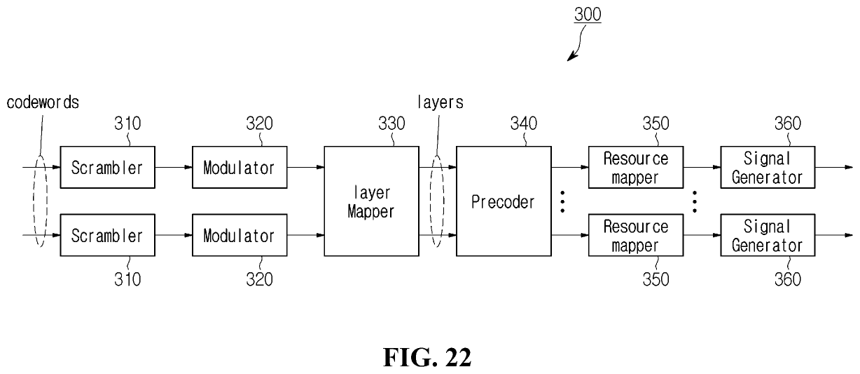

FIG. 22 illustrates a signal process circuit for a transmission signal, in accordance with an embodiment of the present disclosure. The embodiment of FIG. 22 may be combined with various embodiments of the present disclosure.

Referring to FIG. 22, a signal processing circuit 300 may include scramblers 310, modulators 320, a layer mapper 330, a precoder 340, resource mappers 350, and signal generators 360. For example, an operation/function of FIG. 22 may be performed by the processors 202a and 202b and/or the transceivers 36 and 206 of FIG. 21. Hardware elements of FIG. 22 may be implemented by the processors 202a and 202b and/or the transceivers 36 and 206 of FIG. 21. For example, blocks 310 to 360 may be implemented by the processors 202a and 202b of FIG. 21. Alternatively, the blocks 310 to 350 may be implemented by the processors 202a and 202b of FIG. 21 and the block 360 may be implemented by the transceivers 36 and 206 of FIG. 21, and it is not limited to the above-described embodiment.

Codewords may be converted into radio signals via the signal processing circuit 300 of FIG. 22. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 310. Scramble sequences used for scrambling may be generated based on an initialization value, and the initialization value may include ID information of a wireless device. The scrambled bit sequences may be modulated to modulation symbol sequences by the modulators 320. A modulation scheme may include pi/2-Binary Phase Shift Keying (pi/2-BPSK), m-Phase Shift Keying (m-PSK), and m-Quadrature Amplitude Modulation (m-QAM).

Complex modulation symbol sequences may be mapped to one or more transport layers by the layer mapper 330. Modulation symbols of each transport layer may be mapped (precoded) to corresponding antenna port(s) by the precoder 340. Outputs z of the precoder 340 may be obtained by multiplying outputs y of the layer mapper 330 by an N*M precoding matrix W. Herein, N is the number of antenna ports and M is the number of transport layers. The precoder 340 may perform precoding after performing transform precoding (e.g., DFT) for complex modulation symbols. Alternatively, the precoder 340 may perform precoding without performing transform precoding.

The resource mappers 350 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 360 may generate radio signals from the mapped modulation symbols and the generated radio signals may be transmitted to other devices through each antenna. For this purpose, the signal generators 360 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures of FIG. 22. For example, the wireless devices (e.g., 200a and 200b of FIG. 21) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

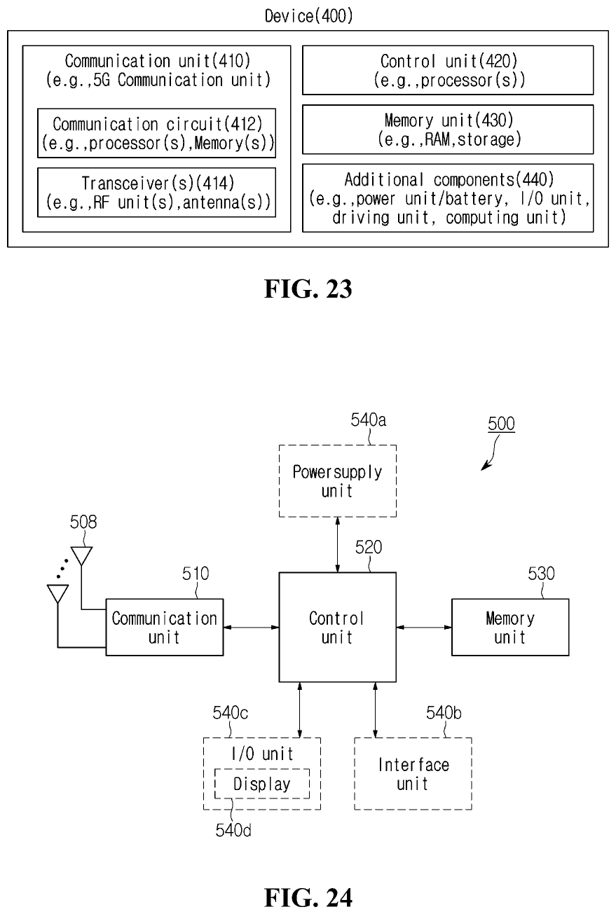

FIG. 23 illustrates a wireless device, in accordance with an embodiment of the present disclosure. The embodiment of FIG. 23 may be combined with various embodiments of the present disclosure.

Referring to FIG. 23, a wireless device 300 may correspond to the wireless devices 200a and 200b of FIG. 21 and include various elements, components, units/portions and/or modules. For example, the wireless device 300 may include a communication unit 310, a control unit (controller) 320, a memory unit (memory) 330 and additional components 340.

The communication unit 410 may include a communication circuit 412 and a transceiver(s) 414. The communication unit 410 may transmit and receive signals (e.g., data, control signals, etc.) to and from other wireless devices or base stations. For example, the communication circuit 412 may include one or more processors 202a and 202b and/or one or more memories 204a and 204b of FIG. 21. For example, the transceiver(s) 414 may include one or more transceivers 206a and 206b and/or one or more antennas 208a and 208b of FIG. 42.

The control unit 420 may be composed of at least one processor set. For example, the control unit 420 may be composed of a set of a communication control processor, an application processor, an electronic control unit (ECU), a graphic processing processor, a memory control processor, etc. The control unit 420 may be electrically coupled with the communication unit 410, the memory unit 430 and the additional components 440 to control overall operation of the wireless device. For example, the control unit 420 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The memory unit 430 may be composed of a random access memory (RAM), a dynamic RAM (DRAM), a read only memory (ROM), a flash memory, a volatile memory, a non-volatile memory and/or a combination thereof. The memory unit 430 may store data/parameters/programs/codes/commands necessary to derive the wireless device 400. In addition, the memory unit 430 may store input/output data/information, etc.

The additional components 440 may be variously configured according to the types of the wireless devices. For example, the additional components 440 may include at least one of a power unit/battery, an input/output unit, a driving unit or a computing unit. Without being limited thereto, the wireless device 400 may be implemented in the form of the robot (FIG. 41, 100a), the vehicles (FIGS. 41, 100b-1 and 100b-2), the XR device (FIG. 41, 100c), the hand-held device (FIG. 41, 100d), the home appliance (FIG. 41, 100e), the IoT device (FIG. 41, 100f), a digital broadcast terminal, a hologram apparatus, a public safety apparatus, an MTC apparatus, a medical apparatus, a Fintech device (financial device), a security device, a climate/environment device, an AI server/device (FIG. 41, 140), the base station (FIG. 41, 120), a network node, etc. The wireless device may be movable or may be used at a fixed place according to use example/service.

FIG. 24 illustrates a hand-held device, in accordance with an embodiment of the present disclosure. FIG. 24 exemplifies a hand-held device applicable to the present disclosure. The hand-held device may include a smartphone, a smart pad, a wearable device (e.g., a smart watch or smart glasses), and a hand-held computer (e.g., a laptop, etc.). The embodiment of FIG. 24 may be combined with various embodiments of the present disclosure.

Referring to FIG. 24, the hand-held device 500 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/440a to 540c may correspond to the blocks 310 to 330/340 of FIG. 23, respectively, and duplicate descriptions are omitted.

The communication unit 510 may transmit and receive signals and the control unit 520 may control the hand-held device 500, and the memory unit 530 may store data and so on. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 540c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

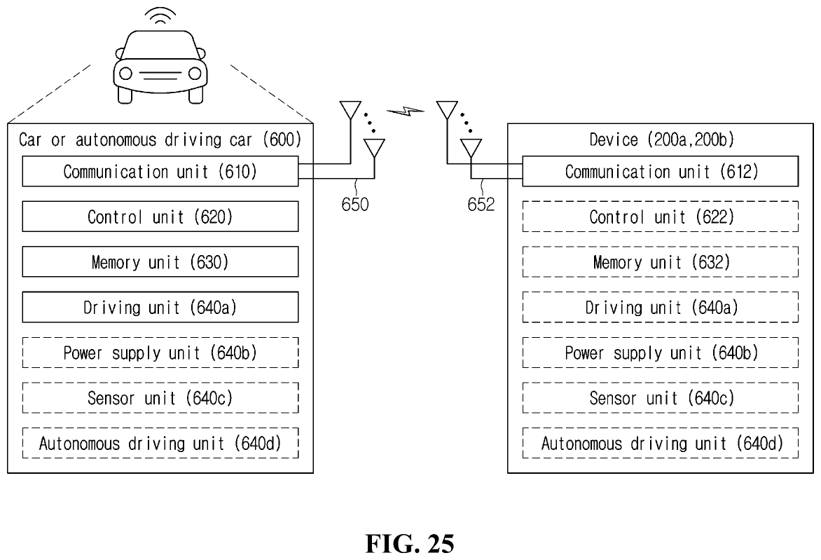

FIG. 25 illustrates a car or an autonomous vehicle, in accordance with an embodiment of the present disclosure. FIG. 25 exemplifies a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited. The embodiment of FIG. 25 may be combined with various embodiments of the present disclosure

Referring to FIG. 25, the car or autonomous driving car 600 may include an antenna unit (antenna) 608, a communication unit (transceiver) 610, a control unit (controller) 620, a driving unit 640a, a power supply unit (power supply) 640b, a sensor unit 640c, and an autonomous driving unit 640d. The antenna unit 650 may be configured as part of the communication unit 610. The blocks 610/630/640a to 640d correspond to the blocks 510/530/540 of FIG. 24, and duplicate descriptions are omitted.

The communication unit 610 may transmit and receive signals (e.g., data, control signals, etc.) to and from external devices such as another vehicle, a base station (e.g., a base station, a road side unit, etc.), and a server. The control unit 620 may control the elements of the car or autonomous driving car 600 to perform various operations. The control unit 620 may include an electronic control unit (ECU). The driving unit 640a may drive the car or autonomous driving car 600 on the ground. The driving unit 640a may include an engine, a motor, a power train, wheels, a brake, a steering device, etc. The power supply unit 640b may supply power to the car or autonomous driving car 600, and include a wired/wireless charging circuit, a battery, etc. The sensor unit 640c may obtain a vehicle state, surrounding environment information, user information, etc. The sensor unit 640c may include an inertial navigation unit (IMU) sensor, a collision sensor, a wheel sensor, a speed sensor, an inclination sensor, a weight sensor, a heading sensor, a position module, a vehicle forward/reverse sensor, a battery sensor, a fuel sensor, a tire sensor, a steering sensor, a temperature sensor, a humidity sensor, an ultrasonic sensor, an illumination sensor, a brake pedal position sensor, and so on. The autonomous driving sensor 640d may implement technology for maintaining a driving lane, technology for automatically controlling a speed such as adaptive cruise control, technology for automatically driving the car along a predetermined route, technology for automatically setting a route when a destination is set and driving the car, etc.

For example, the communication unit 610 may receive map data, traffic information data, etc. from an external server. The autonomous driving unit 640d may generate an autonomous driving route and a driving plan based on the acquired data. The control unit 620 may control the driving unit 640a (e.g., speed/direction control) such that the car or autonomous driving car 600 moves along the autonomous driving route according to the driving plane. During autonomous driving, the communication unit 610 may aperiodically/periodically acquire latest traffic information data from an external server and acquire surrounding traffic information data from neighboring cars. In addition, during autonomous driving, the sensor unit 640c may acquire a vehicle state and surrounding environment information. The autonomous driving unit 640d may update the autonomous driving route and the driving plan based on newly acquired data/information. The communication unit 610 may transmit information such as a vehicle location, an autonomous driving route, a driving plan, etc. to the external server. The external server may predict traffic information data using AI technology or the like based on the information collected from the cars or autonomous driving cars and provide the predicted traffic information data to the cars or autonomous driving cars.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1-20. (canceled)

21. A method of operating a first device in a wireless communication system, the method comprising:
performing communication with a second device;
receiving a discovery signal that is transmitted by a relay device;
transmitting, to the relay device, a first message for requesting a relay service for the first device and the second device;
receiving, from the relay device, a second message for accepting the request for the relay service; and
performing relay communication with the second device,
wherein the first message includes information related to the second device, and
wherein the first message is transmitted based on blocking of a path between the first device and the second device being predicted.

22. The method of claim 21, wherein the discovery signal includes information informing that the relay device provides the relay service.

23. The method of claim 21, wherein the information related to the second device includes at least one of identification information of the second device, location-related information of the second device, a moving speed of the second device, information on a resource used by the second device, security information of the second device, and information related to a spatial domain filter used for the direct communication.

24. The method of claim 21, further comprising:
performing spatial domain filter alignment with the relay device in order to determine at least one of a transmit spatial domain filter and a receive spatial domain filter for the relay communication.

25. The method of claim 21, further comprising:
transmitting a third message for informing the second device that the relay communication is performed.

26. The method of claim 21, wherein the second message includes information associated with at least one of a resource allocated for spatial domain filter alignment between the first device and the relay device and a resource allocated for spatial domain filter alignment between the second device and the relay device.

27. The method of claim 21, wherein the blocking of the path is predicted by predicting intersection turning of a first vehicle in a situation where the first vehicle including the first device is a preceding vehicle and a second vehicle including the second device is a following vehicle.

28. The method of claim 21, wherein a resource pool for the communication and a resource pool for the relay communication are identical with each other.

29. A device comprising at least one memory and at least one processor coupled functionally with the at least one memory,
wherein the at least one processor controls the device to:
perform communication with another device,
receiving a discovery signal that is transmitted by a relay device;
transmit, to the relay device, a first message for requesting a relay service for the device and the another device,
receive, from the relay device, a second message for accepting the request for the relay service, and
perform relay communication with the another device, and
wherein the first message includes information on the another device, and
wherein the first message is transmitted based on blocking of a path between the first device and the second device being predicted.

30. A first device in a wireless communication system, comprising:
a transceiver; and
a processor coupled with the transceiver, wherein the processor is configured to:
perform communication with a second device,
receive a discovery signal that is transmitted by a relay device
transmit, to the relay device, a first message for requesting a relay service for the first device and the second device,
receive, from the relay device, a second message for accepting the request for the relay service, and
perform relay communication with the second device, and
wherein the first message includes information on the second device, and
wherein the first message is transmitted based on blocking of a path between the first device and the second device being predicted.

31. The first device of claim 30, wherein the discovery signal includes information informing that the relay device provides the relay service.

32. The first device of claim 30, wherein the information related to the second device includes at least one of identification information of the second device, location-related information of the second device, a moving speed of the second device, information on a resource used by the second device, security information of the second device, and information related to a spatial domain filter used for the direct communication.

33. The first device of claim 30, wherein the processor is further configured to:
perform spatial domain filter alignment with the relay device in order to determine at least one of a transmit spatial domain filter and a receive spatial domain filter for the relay communication.

34. The first device of claim 30, wherein the processor is further configured to:
transmit a third message for informing the second device that the relay communication is performed.

35. The first device of claim 30, wherein the second message includes information associated with at least one of a resource allocated for spatial domain filter alignment between the first device and the relay device and a resource allocated for spatial domain filter alignment between the second device and the relay device.

36. The first device of claim 30, wherein the blocking of the path is predicted by predicting intersection turning of a first vehicle in a situation where the first vehicle including the first device is a preceding vehicle and a second vehicle including the second device is a following vehicle.

37. The first device of claim 30, wherein a resource pool for the communication and a resource pool for the relay communication are identical with each other.
